(19) United States
(12) Patent Application Publication
(10) Pub. No.: US 2020/0279270 A1
(43) Pub. Date: Sep. 3, 2020

(54) IDENTITY-BACKED AUTHENTICATION AND AUTHORIZATION SYSTEM

(71) Applicants: Dan Lieberman, Seattle, WA (US); Jeffrey Lynn Hagins, Newbury Park, CA (US)

(72) Inventors: Dan Lieberman, Seattle, WA (US); Jeffrey Lynn Hagins, Newbury Park, CA (US)

(21) Appl. No.: 16/289,151

(22) Filed: Feb. 28, 2019

(51) Int. Cl. G06Q 20/40; G06Q 20/38; H04L 9/32; H04L 9/08; G06K 9/00

(52) U.S. Cl. CPC G06Q 20/40145; G06Q 20/3825; H04L 9/3247; G06K 9/00288; H04L 9/0819; G06K 9/00926; G06K 9/00255; H04L 9/3226

(57) ABSTRACT

Disclosed are systems, methods, and non-transitory computer-readable media for authorizing transactions based on a private key stored in secure hardware on an authorized client device. An authorization system receives an external authorization request identifying a user account and a requested action. The authorization system transmits, to a client device associated with the user account, an internal authorization request that causes the client device to present a prompt to authorize the requested action. The authorization system receives an internal authorization message indicating that the requested action has been authorized. The internal authorization message includes a digital signature that was generated by the client device using a private key stored in a secure hardware of the client device. The authorization system verifies the digital signature using a public key associated with the user account and transmits an external authorization message to the remote server authorizing execution of the requested action.

### TECHNICAL FIELD

An embodiment of the present subject matter relates generally to authorizing transactions and, more specifically, to authorizing transactions based on one or more authentication factors, including a private key stored in secure hardware on an authorized client device.

### BACKGROUND

Currently, financial transactions and sensitive data are often managed online. As a result, user authentication, authorization, and data privacy are of the utmost importance. For example, hackers often attempt to access online user accounts to gather sensitive data, transfer money, etc. Currently, security systems are used; however, they do not provide adequate protection. Accordingly, improvements are needed.

### BRIEF DESCRIPTION OF THE DRAWINGS

Various ones of the appended drawings merely illustrate example embodiments of the present disclosure and cannot be considered as limiting its scope.

FIG. 1 shows an example system, wherein an authentication and authorization system is used to authorize requested transactions, according to some example embodiments.

FIG. 2 is a block diagram of a client device, according to some example embodiments.

FIG. 3 is a block diagram of an authentication and authorization system, according to some example embodiments.

FIG. 4 is a block diagram of an enrollment module, according to some example embodiments.

FIG. 5 is a block diagram of an authorization module, according to some example embodiments.

FIG. 6 is a block diagram of an additional device enrollment module, according to some example embodiments.

FIG. 7 is a block diagram of a data transfer module, according to some example embodiments.

FIG. 8 is a flowchart showing an example method of authorizing transactions based on a private key stored in secure hardware on an authorized client device, according to certain example embodiments.

FIG. 9 is a flowchart showing an example method of enrolling a user account with the authentication and authorization system, according to certain example embodiments.

FIG. 10 is a flowchart showing an example method for enrolling an additional device to an existing user account of an authentication and authorization system, according to certain example embodiments.

FIG. 11 is a flowchart showing an example method of securely transferring private data using the authentication and authorization system, according to certain example embodiments.

FIG. 12 is a diagrammatic representation of a machine in the example form of a computer system within which a set of instructions for causing the machine to perform any one or more of the methodologies discussed herein may be executed.

### DETAILED DESCRIPTION

Disclosed are systems, methods, and non-transitory computer-readable media for authorizing transactions based on one or more authentication factors, but in all cases beginning with a private key stored in secure hardware on an authorized client device. An authentication and authorization system acts as an intermediary between users and third parties to authorize requested transactions. For example, when a user attempts to perform a transaction with a third-party service that requires user authorization (e.g., logging in to a user account, transferring money, transferring or accessing personal information, etc.) the third-party online service transmits an external authorization request to the authentication and authorization system. The external authorization request includes a unique identifier (e.g., username) associated with the user's account with the authorization system and identifies the requested transaction (e.g., logging in to a user account, transferring money, transferring or accessing personal information, etc.). in response to receiving the external authorization request, the authorization system in turn transmits an internal authorization request to a client device or client devices (e.g., smart phone(s), laptop(s), tablet(s), etc.) authorized on the user's account. The internal authorization request causes the client device to present a prompt to authorize the requested transaction. The prompt included data describing the requested transaction, which the user may use to review in deciding whether to authorize the transaction. If the user authorizes the transaction, the client device transmits an internal authorization message to the authorization system, which in turn transmits an external authorization message to the third-party online service. The external authorization message instructs the third-party online service to execute the requested transaction.

The authentication and authorization system uses multiple authentication factors to ensure that authorization for the requested transaction is provided by the correct user. These factors can authenticate that the user providing the authorization is the correct user associated with the user account, rather than a hacker or other fraudulent user. One authentication factor used by the authentication and authorization system is a unique private/public key pair generated for the user's client device. The private key is generated and stored by secure hardware of the client device. Secure hardware on the client device functions as a hardware-based key manager that is isolated from the main processor of the client device to provide an extra layer of security. Private keys stored in the secure hardware are not directly handled or accessed by applications executing on the client device, making them very difficult to compromise. Rather, an application instructs the secure hardware to create the private/public key pair, securely store the private key, and perform cryptographic operations using the stored private key. The application receives only the output of these operations, such as encrypted data or a cryptographic signature verification outcome. An example of a secure hardware is Secure Enclave provided by Apple, Inc., in their client devices.

The public key generated by the secure hardware is provided to the authentication and authorization system, which stores the public key in a data storage system which may be a distributed database, such as a distributed ledger, blockchain, etc. To verify that an internal authorization message authorizing a requested transaction is received from the correct client device, the client device generates a cryptographic signature using the private key stored in the secure storage of the client device and provides the cryptographic signature to the authentication and authorization system as part of the internal authorization message. The authentication and authorization system uses the corresponding public key to verify whether the cryptographic signature included in the internal authorization message was generated using the private key corresponding to the client device. This ensures that the internal authorization message was received from the correct client device, rather than the client device of a hacker or other fraudulent user.

Another authentication factor that may be used by the authentication and authorization system is a captured image of the user. For example, the client device captures an image of the user prior to allowing a user to select to allow or deny an internal authorization request. The captured image is compared to one or more previously captured and verified images of the user associated with the user account to ensure that the user using the client device is the same user associated with the user account. This image comparison and verification can be performed at the client device or at the authentication and authorization system.

Another authentication factor that may be used is a passcode. For example, the client device prompts the user for the user's preset passcode prior to allowing the user to select to allow or deny an internal authorization request. The client device may deny attempts to authorize a requested transaction if the correct passcode is not provided.

Another authentication factor that may be used is a biometric data item. A biometric data item is data describing a gathered body measurement, such as a fingerprint, eye scan, etc. The client device may prompt the user for a biometric data item prior to allowing the user to select to allow or deny the internal authorization request. The collected biometric data item is compared to a previously captured and verified version of the biometric data item to authenticate that the user attempting to provide authorization is the user associated with the user account.

The functionality of the authentication and authorization system may be used to provide identity backed authorization for a variety of types of actions, such as account access, device registration, monetary transfers, transfer of private data, multiple account access, etc. The authentication and authorization system implements multiple novel steps to verify the identity of an individual. This high level of verification allowed the authentication and authorization system to authenticate with a high degree of likelihood that the person authorizing a transaction is in fact the person in question. The functionality of the authentication and authorization system and its various potential uses are described in greater detail below in relation to the figures.

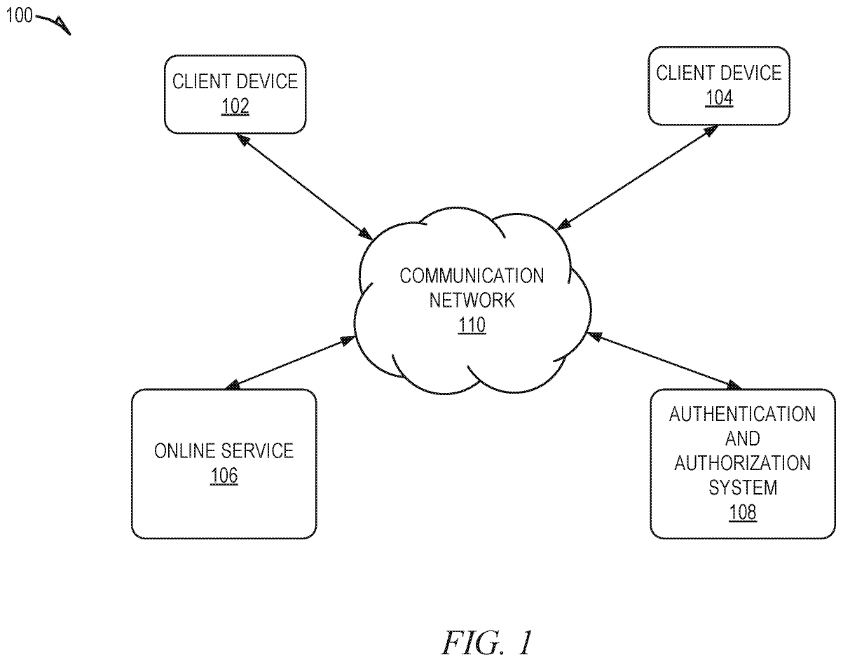

FIG. 1 shows an example system 100, wherein an authentication and authorization system 108 is used to authorize requested transactions. As shown, multiple computing devices/computing systems (e.g., client device 102, client device 104, online service 106, and authentication and authorization system 108) are connected to a communication network 110 and configured to communicate with each other through use of the communication network 110. The communication network 110 is any type of network, including a local area network (LAN), such as an intranet, a wide area network (WAN), such as the Internet, or any combination thereof. Further, the communication network 110 may be a public network, a private network, or a combination thereof. The communication network 110 is implemented using any number of communications links associated with one or more service providers, including one or more wired communication links, one or more wireless communication links, or any combination thereof. Additionally, the communication network 110 is configured to support the transmission of data formatted using any number of protocols.

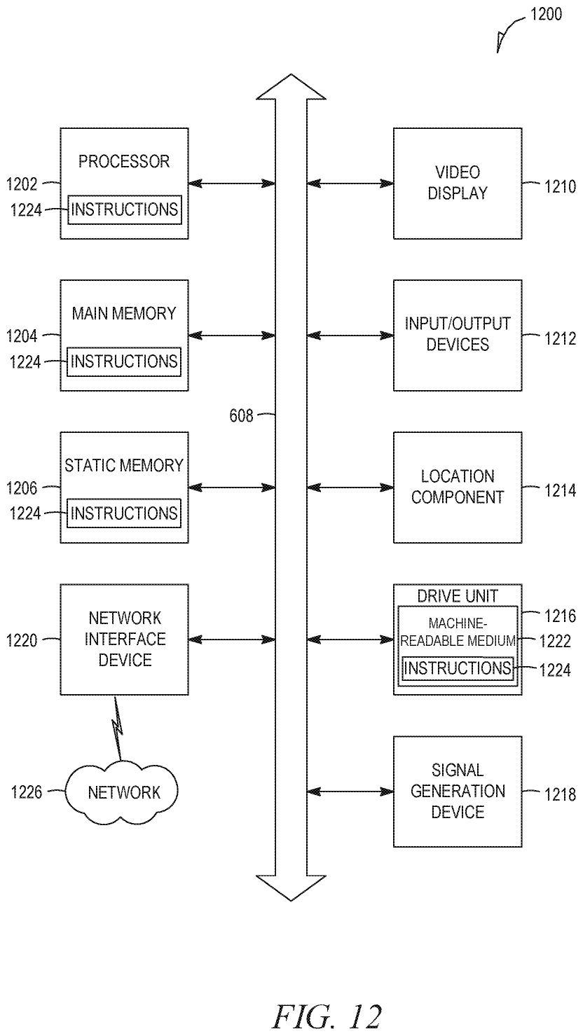

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the computer system 1200 shown in FIG. 12.

To facilitate communication with other computing devices, a computing device includes a communication interface configured to receive a communication, such as a request, data, and the like, from another computing device in network communication with the computing device and pass the communication along to an appropriate module (or software engine) running on the computing device. The communication interface also sends a communication to another computing device in network communication with the computing device.

In the system 100, users interact with the online service 106 and the authentication and authorization system 108 using the client devices 102 and 104 that are connected to the communication network 110 by direct and/or indirect communication. Although the shown system 100 includes only two client devices 102, 104, this is only for ease of explanation and is not meant to be limiting. One skilled in the art would appreciate that the system 100 can include any number of client devices 102, 104. Further, the online service 106 and authentication and authorization system 108 may concurrently accept connections from and interact with any number of client devices 102, 104. The online service 106 and authentication and authorization system 108 support connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with the online service 106 and/or the authentication and authorization system 108 using client-side applications installed on the client devices 102 and 104. For example, the client devices 102, 104 may include a client-side application corresponding to the online service 106, which a user uses to interact with the online service 106, as well as a client-side application corresponding to the authentication and authorization system 108, which a user uses to interact with the authentication and authorization system 108.

In some embodiments, the client-side applications include a component specific to their corresponding service (e.g., online service 106, authentication and authorization system 108). For example, the component may be a stand-alone application, one or more application plug-ins, and/or a browser extension. However, the users may also interact with the online service 106 and authentication and authorization system 108 via a third-party application, such as a web browser, that resides on the client devices 102 and 104 and is configured to communicate with the online service 106 and authentication and authorization system 108. In either case, the client-side applications or third-party applications present a user interface (UI) for the user to interact with the online service 106 and authentication and authorization system 108. For example, the user interacts with the online service 106 and authentication and authorization system 108 via client-side applications integrated with the file system or via a webpage displayed using a web browser application.

The online service 106 may be any type of service provided online. For example, the online service 106 may be a banking service that allows users to access their personal bank account(s), transfer funds, make payments, etc. As another example, the online service may be a social networking service in which a user may use their user account to post messages, read messages posted by other users, etc. As another example, the online service 106 may be a cloud data management service that allows users to store and access files from the cloud. As another example, the online service 106 may be an online marketplace service that allows users to purchase and/or sell items. These are just a few examples and are not meant to be limiting. Although the system 100 is show as including only a single online service 106, this is just for ease of explanation and is not meant to be limiting. The system 100 may include any number of online services 106.

The authentication and authorization system 108 confirms user authorization for requested transactions. For example, the authentication and authorization system 108 receives authorization requests (e.g., from the online service 106, directly from a client device 102) to perform a requested transaction, confirms that the user has authorized the requested transaction, and returns confirmation that the requested transaction has been authorized by the user.

A user transaction may be any type of transaction or action performed online for which a user's permission is needed. For example, a transaction may be associated with an online service, such as logging into a user account with the online service 106, creating a new user account with the online service 106, transferring funds using the online service 106, changing a username or password for the online service 106, transferring sensitive data using the online service 106, etc. As another example, the user transaction may be a user attempting login to their personal client device 102, 104, such as the user's laptop, desktop computer, etc. These are just a few examples of a transaction and are not meant to be limiting.

To utilize the functionality of the authentication and authorization system 108, a user initially creates a user account with the authentication and authorization system 108. This includes completing an enrollment process during which the user is prompted to provide specified data to the authentication and authorization system 108. The authentication and authorization system 108 verifies the specified data for authenticity.

The authentication and authorization system 108 also causes a private/public key pair to be generated for the new user account. For example, the authentication and authorization system 108 instructs a secure hardware of the registering user's client device 102 to generate the private/public key pair. The private key is stored in the secure hardware of the client device 102 and the public key is returned to the authentication and authorization system 108, where it is stored. and associated with the user account.

After a user has created a user account with the authentication and authorization system 108, the online service 106 and the authentication and authorization system 108 can communicate with each other to provide authorization from the user for requested transactions. To receive authorization for a requested transaction, the online service 106 transmits an external authorization request to the authentication and authorization system 108 requesting authorization for the requested transaction. For example, the online service 106 transmits the external authorization request in response to the user requesting to perform the requested transaction with respect to the online service 106, such as attempting to log into a user account of the online service 106, attempting to transfer funds, etc. The external authorization request includes data identifying the requested transaction as well as a unique identifier (e.g., username) corresponding to the requesting user's account with the authentication and authorization system 108.

In response to receiving the external authorization request, the authentication and authorization system 108 in turn transmits an internal authorization request to a client device 102 authorized on the user's account. The internal authorization request causes the client device 102 to present a prompt to authorize the requested transaction. The prompt includes data describing the requested transaction, which the user reviews to decide whether to authorize the transaction. If the user authorizes the transaction, the client device 102 transmits an internal authorization message to the authentication and authorization system 108, which in turn transmits an external authorization message to the online service 106. The external authorization message instructs the online service 106 to execute the requested transaction.

The authentication and authorization system 108 uses multiple authentication factors to ensure that authorization for the requested transaction is provided by the correct user. These factors can ensure that the user providing the authorization is the correct user, rather than a hacker or other fraudulent user. One authentication factor used by the authorization system is the private/public key pair generated for the user account.

To verify that a requested transaction is received from the correct client device 102, the client device 102 generates a cryptographic signature using the private key stored in the secure storage and provides the cryptographic signature to the authentication and authorization system 108 as part of the internal authorization message. The authentication and authorization system 108 uses the corresponding public key to verify whether the cryptographic signature was generated using the private key corresponding to the client device 102. This ensures that the authorization request was received from the correct client device 102, rather than a client device 102 of a hacker or other fraudulent user.

Another authentication factor that may be used by the authentication and authorization system 108 is a captured image of the user. In this type of embodiment, the client device 102 captures an image of the user as part of the process to authorize an internal authorization request (e.g., prior to allowing the user to authorize the requested action). The captured image is compared to one or more previously captured and verified images of the user associated with the user account to ensure that the user using the client device 102 is the same user associated with the user account. This image comparison and verification can be performed at the client device 102 or at the authentication and authorization system 108.

Another authentication factor that may be used is a passcode. For example, the client device 102 prompts the user for the user's preset passcode as part of the process to authorize an internal authorization request. The client device 102 may deny attempts to authorize a requested transaction unless the correct passcode is provided.

Another authentication factor that may be used is a biometric data item. A biometric data item is data describing a gathered body measurement, such as a fingerprint, eye scan, etc. The client device 102 may prompt the user for a biometric data item during the process of authorizing the internal authorization request. The collected biometric data item is compared to a previously captured and verified version of the biometric data item to verify that the user attempting to provide authorization is the user associated with the user account.

The authentication and authorization system 108 may utilize any or more of these described authentication factors to verify the identity of a user authorizing a transaction. The functionality of the authorization system may be used to authorize a variety of types of transaction, such as account access, device registration, monetary transfers, transfer of private data, etc.

In addition to being used to authenticate an authorizing user, the public/private key pair generated for a user account may also be used to encrypt and. transfer personal and/or sensitive data. For example, personal and/or sensitive data may be encrypted using a private or public key and transferred between devices. These types of example embodiments are described in greater detail below.

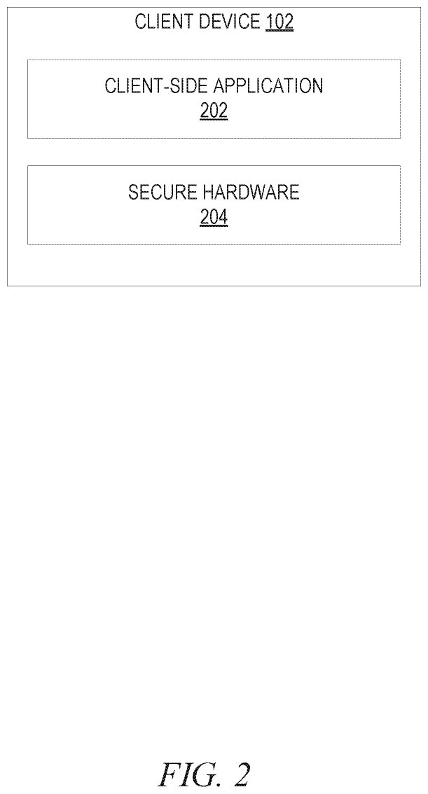

FIG. 2 is a block diagram of a client device 102, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the client device 102 to facilitate additional functionality that is not specifically described herein. Furthermore, the various functional modules depicted in FIG. 2 may reside on a single computing device or may be distributed across several computing devices in various arrangements such as those used in cloud-based architectures. For example, the various functional modules and components may be distributed the client device 102 and the authentication and authorization system 108.

As shown, the client device 102 includes a client-side application 202 and a secure hardware 204. The client-side application 202 enables a user to interact with the authentication and authorization system 108. In some embodiments, the client-side application 202 includes an authentication and authorization system 108 specific component. For example, the component may be a stand-alone application, one or more application plug-ins, and/or a browser extension. However, the client-side application 202 may also be a third-party application, such as a web browser, that is configured to communicate with the authentication and authorization system 108. In either case, the client-side application 202 presents a user interface (UI) for the user to interact with the authentication and authorization system 108. Although the client device 102 is shown as including only one client-side application 202, this is just for ease of explanation and is not meant to be limiting. The client device 102 may include any number of client-side applications 202 configured to provide a. variety of services and/or corresponding to a variety of online services 106.

The secure hardware 204 on the client device 102 functions as a hardware-based key manager that is isolated from the main processor (not shown) of the client device 102 to provide an extra layer of security. Private keys stored in the secure hardware 204 are not directly handled or accessed by the client-side application 202 executing on the client device 102, making them very difficult to become compromised. Rather, the client-side application 202 instructs the secure hardware 204 to create a private/public key pair, securely store the private key, and perform operations with it. The client-side application 202 receives only the output of these operations, such as encrypted data or a cryptographic signature verification outcome. An example of a secure hardware 204 is Secure Enclave provided by Apple.

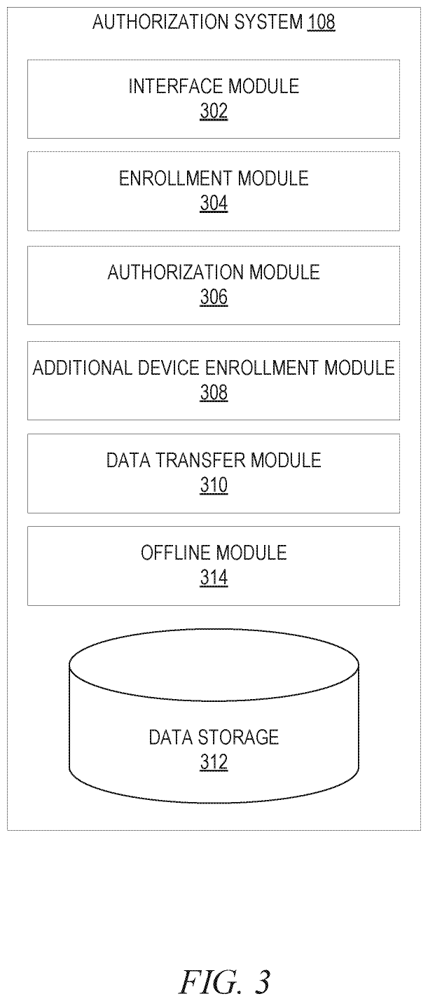

FIG. 3 is a block diagram of the authentication and authorization system 108, according to some example embodiments. To avoid obscuring the inventive subject matter with unnecessary detail, various functional components (e.g., modules) that are not germane to conveying an understanding of the inventive subject matter have been omitted from FIG. 3. However, a skilled artisan will readily recognize that various additional functional components may be supported by the authentication and authorization system 108 to facilitate additional functionality that is not specifically described herein. Furthermore, the various functional modules depicted in FIG. 3 may reside on a single computing device or may be distributed across several computing devices in various arrangements such as those used in cloud-based architectures. For example, the various functional modules and components may be distributed amongst the authentication and authorization system 108 and a client device 102 including a client-side application 202 corresponding to the authentication and authorization system 108.

As shown, the authentication and authorization system 108 includes an interface module 302, an enrollment module 304, an authorization module 306, an additional device enrollment module 308, a data transfer module 310, an offline module 314, and a data storage 312.

The interface module 302 facilitates presentation of a user interface on a client device 102 that allows a user of the client device 102 to interact with and utilize the functionality of the authentication and authorization system 108. For example, the user interface includes user interface elements, such as buttons, text fields, etc., that a user may use to enter data, select functionality, and otherwise interact with the authentication and authorization system 108.

The enrollment module 304 facilitates the enrollment process during which a user creates a user account with the authentication and authorization system 108. For example, the enrollment module 304 creates a user account for the user and prompts the user for specified data, such as personal information (e.g., name, address, social security number, driver's license number, etc.), biometric data (e.g., fingerprint, face scan, retina scan, etc.), an image of the user, a captured image of one or more of the user's government-issued identity documents (including but not limited to a driver's license or a passport), etc. The enrollment module 304 causes the client-side application 202 to collect certain data using sensors of the client device 102. For example, an optical sensor (e.g., camera) of the client device 102 can be used to capture an image of the user, capture an image of the user's driver's license, perform a face or retina scan, etc. As another example, a biometric sensor, such as a fingerprint sensor, may be used to capture a fingerprint of the user.

As part of the enrollment process, the enrollment module 304 further generates a private/public key pair for the user account, which corresponds to the client device 102 used by the user during the enrollment process. The public/private key pair is unique to the client device 102. Accordingly, if a user were to add another client device 104 to their user account, a different public/private key pair would be generated for the newly added client device 104. To generate the public/private key pair, the enrollment module 304 causes the client-side application 202 to instruct the secure hardware 204 to generate the private/public key pair. Once generated, the private key is maintained by the secure hardware 204 on the client device 102, and the public key is returned to the authentication and authorization system 108. Accordingly, neither the authentication and authorization system 108 nor the client-side application 202 has direct access to the private key.

The enrollment module 304 stores the public key at the authentication and authorization system 108 and associates the public key with its corresponding client device 102. In some embodiments, the enrollment module 304 stores the public key in a distributed database, such as a distributed ledger, blockchain, etc.

The enrollment module 304 verifies the data received from the user. For example, the enrollment module 304 may communicate with third-party services (not shown) to verify the user's provided social security number, driver's license, name, address, etc. The enrollment module 304 may also perform an image analysis and comparison between the image captured of the user and the image on the user's provided driver's license. This can be used to confirm that the provided the driver's license belongs to the user that provided the image and is attempting to enroll with the authentication and authorization system 108.

The enrollment module 304 may also verify that the client device 102 being used throughout the enrollment process is the same client device 102. This protects against attempts to forward communications to a different client device 102 than the client device 102 that was initially used to initiate the enrollment process. To accomplish this, the enrollment module 304 sends a message to the client device 102 (e.g., Short Message Service (SMS) message) that includes a deep link for the client-side application 202. The deep link, when actuated by a user, causes execution of the client-side application 202 on the client device 102, and causes the client-side application 202 to generate and transmit a verification message back to the authentication and authorization system 108. The verification message includes a digital signature (e.g., cryptographic signature) that was generated using the private key stored in the secure hardware 204 of the client device 102. For example, the client-side application 202 instructs the secure hardware 204 to generate the cryptographic signature, which the client-side application 202 then includes in the verification message transmitted back to the authentication and authorization system 108. The enrollment module 304 uses the public key corresponding to the client device 102 to verify that the digital signature was generated using the corresponding private key, which confirms that the digital signature was generated by the same client device 102 that was used to initiate the enrollment process.

Once a user's data has been verified and the user account has been created, the enrollment module 304 may delete some or all of the data received from the user during the enrollment process. For example, the enrollment module 304 may delete any sensitive data, such as the user's social security number, copy of the user's driver's license, etc. In some embodiments, the enrollment module 304 may maintain some of the data, such as the captured image of the user, in the data storage 312. To provide additional security, the stored data may be encrypted using the public key prior to storage. Accordingly, a hacker would not be able to access the data without the corresponding private key stored in the secure storage of the client device 102. The user's sensitive data may be stored at the client device 102 in the secure hardware 204. The sensitive data may be encrypted prior to storage, for example using the private key stored in the secure hardware 204.

In some embodiments, the enrollment module 304 may maintain a hash of the user's sensitive data. The hash maintains the privacy of the user, while also being used to verify a user's sensitive data. For example, a third-party may use the same hashing algorithm to generate a hash of information provided by a user. The third-party service may then provide the hash to the authentication and authorization system 108, where it is compared to the stored hash to verify the information.

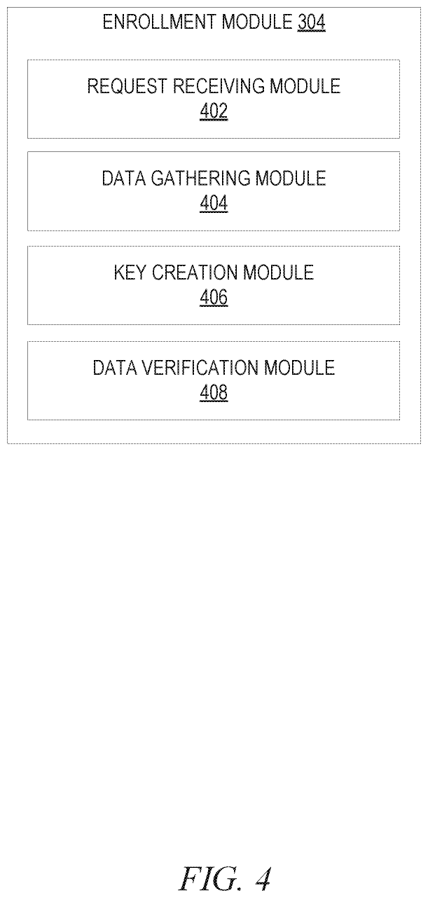

The functionality of the enrollment module 304 is described in greater detail in relation to FIG. 4.

The authorization module 306 provides authorization for a requested transaction. For example, the authorization module 306 receives external authorization requests to perform a requested transaction. An external authorization request is a request for authorization to perform a specified transaction that is transmitted to the authentication and authorization system 108 from a device external to the authentication and authorization system 108 (e.g., online service 106, client devices 102, 104). For example, an external authorization request may be received from an online service 106 as a result of a user attempting to perform a transaction on the online service 106. Some transactions may be designated by the online service 106 and/or the user as requiring authorization from the user via the authentication and authorization system 108, such as logging into a user account, transferring monetary funds, purchasing an item, accessing or transferring personal information.

The external authorization request includes data describing the requested transaction and a unique identifier associated with a user account of the authentication and authorization system 108, such as the username used to log into the user's account with the authentication and authorization system 108. For example, the user may be prompted by the online service 106 to enter their username with the authentication and authorization system 108 to perform the requested transaction on the online service 106. As another example, the online service 106 may have the user's username with the authentication and authorization system 108 stored in a user profile of the user with the online service 106. The online service 106 accesses the username from the user's profile with the online service 106 when the user requests to perform the transaction and the transmits the username to the authentication and authorization system 108 as part of the external authorization request.

The authorization module 306 uses the unique identifier included in the external authorization request to identify and access the corresponding user account from the data storage 312. The authentication and authorization system 108 identifies the one or more client devices 102, 104 that are authorized on the user's account from the user's account.

The authorization module 306 then generates and transmits an internal authorization request to the authorized client devices 102, 104. An internal authorization request is a request for a user to authorize a requested transaction that is transmitted by the authentication and authorization system 108 to client devices 102, 104 that are authorized on a user's account.

The internal authorization request causes the client devices 102, 104 to present a prompt on their respective displays that describes the requested transaction and enables the user to either select to approve or deny the requested transaction. For example, the internal authorization request causes the client-side application 202 to present a user interface on a display of the client device 102, which includes text identifying the requested transaction along with user interface elements, such as buttons, which a user may select to either approve or deny the request.

In some embodiments, the prompt may include an image generated by the authentication and authorization system 108 when requesting to access a service to ensure that the internal authorization request is the result of the user's request rather than a spoofed authorization request. The same image is presented on both client devices 102 and 104, and the user views the image presented on both displays to ensure that the images match. If the images do not match, the user may assume that the internal authorization request is improper or fraudulent and should therefore deny the request.

The user's selection to either approve or deny the request in turn causes the client-side application 202 to generate and transmit an internal authorization message to the authentication and authorization system 108. An internal authorization message is a message sent from an authorized client device 102, 104 to the authentication and authorization system 108 as a response to an internal authorization request. The internal authorization system indicates the user's selection to either approve or deny the requested transaction. For example, an internal authorization message may indicate that the user has selected to authorize the requested transaction or, alternatively, indicate that the user has selected to deny the requested transaction.

The authorization module 306 receives an internal authorization message from a client device 102, 104 and transmits a corresponding external authorization message. An external authorization message is a message transmitted by the authentication and authorization system 108 to an external device as a reply to the external authorization request. The external authorization message indicates whether the requested action should be allowed or denied. For example, the authorization module 306 transmits the external authorization message to the online service 106 from which the external authorization request was received. The online service 106 allows or denies the requested transaction based on the user selection indicated in the external authorization message.

The authorization module 306 uses multiple authentication factors to ensure that authorization for the requested transaction is provided by the correct user (e.g., the user associated with the user account). These factors can ensure that the user providing the authorization is the correct user, rather than a hacker or other fraudulent user.

One authentication factor used by the authorization module 306 is the unique private/public key pair generated for the client device 102. The private/public key pair is generated by the secure hardware 204 of the client device 102 during the enrollment process. The private key is stored in the secure hardware 204, and the public key is returned to the authentication and authorization system 108, where it is stored and associated with the corresponding user account and/or client device 102. For example, the public key may be stored in a distributed database, such as a distributed ledger, blockchain, etc.

The private key stored in the secure hardware 204 is used to generate a digital signature (e.g., cryptographic signature), which is included in the internal authorization message transmitted from the client device 102 to the authentication and authorization system 108. For example, the client-side application 202 instructs the secure hardware 204 to generate the digital signature, and then includes the digital signature generated by the secure hardware 204 in the internal authorization message that is transmitted to the authentication and authorization system 108. The authorization module 306 uses the corresponding public key to verify the digital signature included in the received internal authorization message. This ensures that the internal authorization request was received from the correct client device 102, rather than the client device 102 of a hacker or other fraudulent user, and further ensures that the response to the internal authorization request has not been altered in transit.

Another authentication factor that may be used is an image captured of the user at authorization time compared to previously captured and verified image of the user. The user may be prompted to provide an image of him/herself during the enrollment process, which is verified by the enrollment module 304. This verified image is stored at the client device 102 and/or the authentication and authorization system 108. To provide authorization for a requested action, a user of the client device 102 is prompted by the client device 102 to pose for an image, which is captured using an optical sensor (e.g., camera) of the client device 102. The captured image is then compared to the previously captured and verified image of the user associated with the user account to ensure that the user using the client device 102 is the same user associated with the user account. For example, the client device 102 compares the captured image to the previously captured image which is stored at the client device 102. Alternatively, the captured image is transmitted by the client device 102 to the authentication and authorization system 108 and the authorization module 306 compares the captured image to the previously captured and verified image of the user that is stored by the authentication and authorization system 108.

Another authentication factor that may be used is a passcode. For example, the client device 102 prompts the user for the user's preset passcode as part of the process to authorize an internal authorization request. The presented passcode may be a code utilized by the client device 102 to log into the client device 102, or alternatively, a preset passcode set by the authentication and authorization system 108 during the enrollment process with the authentication and authorization system 108. The client device 102 denies attempts to authorize a requested transaction in the event that the correct passcode is not provided.

Another authentication factor that may be used is a biometric data item collected from the user. A biometric data item is data describing a gathered body measurement, such as a fingerprint, eye scan, etc. The client device 102 may prompt the user for a biometric data item during the process of authorizing the internal authorization request. The biometric data item is collected using a sensor of the client device 102, such as an optical sensor (e.g., camera), fingerprint scanner, etc. The collected biometric data item is compared to a previously captured and verified version of the biometric data item to verify the identity of the user. The previously captured and verified version of the biometric data item may be a biometric data item collected and used by the client device 102 as part of the login process for the client device 102 itself, or alternatively, a biometric data item collected by the authentication and authorization system 108 during the enrollment process with the authentication and authorization system 108.

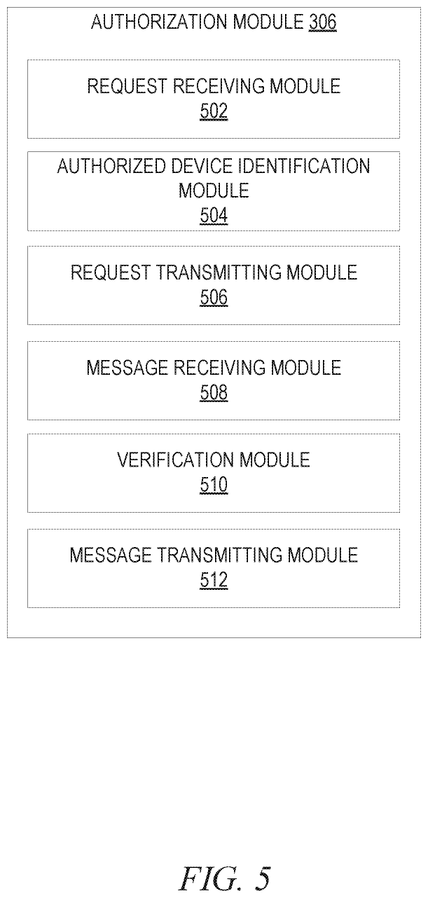

The functionality of the authorization module 306 is described in greater detail in relation to FIG. 5.

The additional device enrollment module 308 enables the process by which a user may add an additional client device 102 to their existing user account. A user may enroll multiple client devices 102, 104 to their user account, which can then be used to authorize a requested transaction. To enroll an additional client device 102, a user initially communicates with the authentication and authorization system 108 to request to add the additional client device 102 to an existing user account of the authentication and authorization system 108. For example, the user uses the additional client device 102 the user would like to add to the their user account, or alternatively a client device 104 already authorized on their user account. In either case, the user provides data identifying their user account and the additional client device 102 they would like added to their user account. For example, the user may provide the phone number associated with the additional client device 102.

The additional device enrollment module 308 treats the request as an external authorization request to execute the requested transaction of adding the additional client device 102. Accordingly, the additional device enrollment module 308 communicates with the authorization module 306 to execute the authorization process, such as transmitting an internal authorization request to a client device 104 already authorized on the user account, verifying a digital signature received in an internal authorization message, etc.

Once authorization for the requested transaction is received, the additional device enrollment module 308 updates the user account to indicate that the additional client device 102 is now an authorized device on the user account. The additional device enrollment module 308 also generates a private/public key pair for the additional client device 102. That is, the additional device enrollment module 308 instructs the client-side application 202 installed on the additional client device 102 to communicate with the secure hardware 204 on the additional client device 102 to generate the private/public key pair. The additional client device 102 stores the private key in the secure hardware 204 of the additional client device 102 and returns the public key to the authentication and authorization system 108. The additional device enrollment module 308 in turn transmits the public key for the additional client device 102 to a client device 104 that was previously authorized on the user account. The previously authorized client device 104 uses the received public key to encrypt any sensitive data stored on the previously authorized client device 104 (e.g., in the secure hardware 204 of the previously authorized client device 104). The encrypted sensitive data can be decrypted using the private key stored in the secure hardware 204 of the additional client device 102 to be added to the user account.

The previously authorized client device 104 returns the encrypted data to the authentication and authorization system 108. The additional device enrollment module 308 in turn transmits the encrypted data to the additional client device 102, which uses the private key stored in the secure hardware 204 of the additional client device 102 to decrypt and store the sensitive data. For example, the sensitive data is stored in the secure hardware 204 of the additional client device 102. After forwarding the encrypted sensitive data to the additional client device 102, the additional device enrollment module 308 may delete the encrypted sensitive data received at the authentication and authorization system 108.

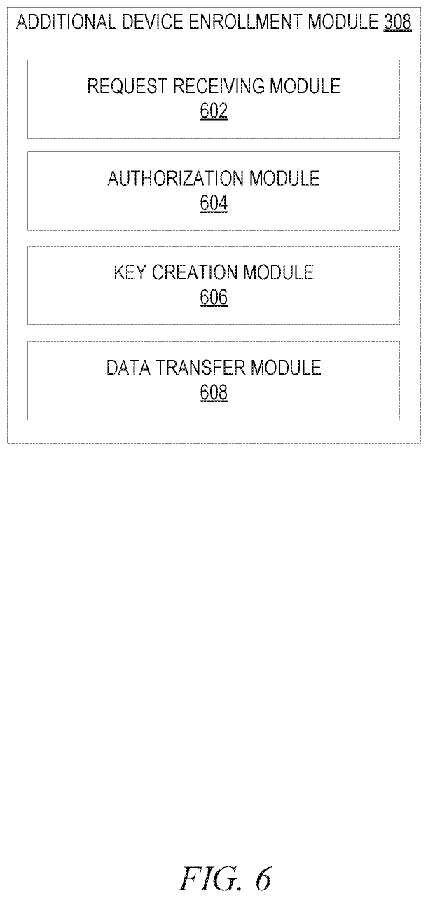

The functionality of the additional device enrollment module 308 is described in greater detail in relation to FIG. 6.

The data transfer module 310 facilitates the secure transfer of sensitive data to a requesting party. For example, a banking institution may request the sensitive data as part of processing a loan application, credit card application, etc. In response to receiving an external authorization request to transfer a user's sensitive data, the data transfer module 310 communicates with the enrollment module 304 to execute the authorization process, such as transmitting an internal authorization request to a client device already authorized on the user account, verifying a digital signature received in an internal authorization message, etc.

The data transfer module 310 transmits a public key associated with the requesting party to an authorized client device 102 of the user. This public key may be included in the internal authorization request or transmitted after authorization for the requested transaction is received. The authorized client device 102 uses the public key to encrypt the requested sensitive data stored in the secure hardware of the client device 102. The client device 102 returns the encrypted sensitive data to the authentication and authorization system 108, after which the data transfer module 310 transfers the encrypted data to a client device 104 of the requesting party. The requesting party may decrypt the encrypted sensitive data using the private key stored by the client device 104 of the requesting part. After transferring the encrypted sensitive data to the requesting party, the data transfer module 310 may delete the encrypted sensitive data received by the authentication and authorization system 108.

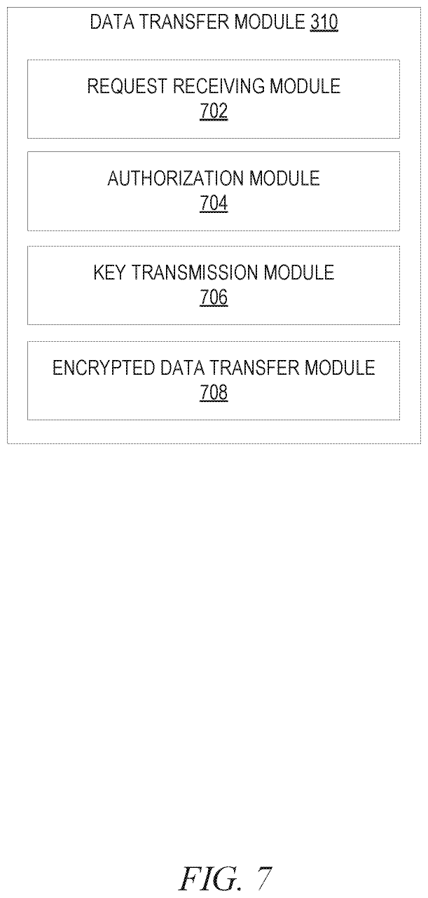

The functionality of the data transfer module 310 is described in greater detail in relation to FIG. 7.

The offline module 314 provides authorization for a requested transaction in instances in which a client device 102 is offline (e.g., does not have internet access) and cannot communicate directly with the authentication and authorization system 108. This may occur in one of two ways; either the client device 102 that a user uses to provide authorization for requested transactions does not have internet access or the user is attempting to login to a client device 104 that does not have internet access. The offline module 314 provides functionality to provide authorization for a requested transaction in either situations, which is described in turn below.

In situations in which the client device 102 used to authorize requested transactions is offline, a user may use another client device 104 in conjunction with their client device 102 to generate an internal authorization message to authorize the requested transaction. This may occur in situations when the user is travelling abroad and does not have service in the area. The offline module 314 provides a website that a user may access in these situations using another client device 104 that does have access to the interne, such as a computer located in a hotel or internet café. The user accesses the website facilitated by the offline module 314 to indicate that their client device 102 is offline. The website prompts the user to provide their account identifier, such as a user name.

The offline module 314 may confirm whether the client device 102 is in fact offline. For example, the offline module 314 attempts to reach the client device 102 by transmitting a request message for the client device 102 to respond (e.g., pinging the client device 102). The offline module 314 determines that the client device 102 is offline if a negative acknowledgement is received or a timeout period has elapsed without receiving a response.

If the offline module 314 determines that the client device 102 is unreachable (e.g., offline), the offline module 314 generates a code that is provided to the client-side application 202 executing on the user's offline client device 102. For example, the code may be presented on the website and the user may use an optical sensor on their client device 102 to capture an image of the code. As another example, the user may manually enter the code into the client device 102. As another example, the code may be transmitted between the client device 102 and the other client device 104 using a communication protocol such as Bluetooth.

The code generated by the offline module 314 includes data that the client-side application 202 uses to generate a verification code that includes a digital signature generated using the private key stored in the secure hardware 204 of the client device 102. The client-side application 202 causes the verification code to be returned to the other client device 102. For example, the client-side application 202 may cause the verification code to be presented on a display of the client device 102, where it can be captured by an optical sensor of the client device 104 or entered manually by a user. The verification code may be transmitted between the client device 102 and the other client device 104 using a communication protocol such as Bluetooth.

The verification code, when received by the offline module 314, acts as a substitute for an internal authorization message. The offline module 314 uses the corresponding public key to verify the digital signature included in the received internal authorization message and then causes an external authorization message to be transmitted to authorize the requested transaction.

In situations in which the user would like to login to an offline client device 104 that requires authorization via the authentication and authorization system 108, the user may use the client device 102 that they use to authorize transactions in conjunction with the offline client device 104 to generate an external authorization request. To accomplish this, the offline client device 104 generates a code that includes data describing the requested transaction (e.g., logging into the offline client device 104). The offline client device 104 provides the code to the user's client device 102. For example, the offline client device 104 presents the code on a display of the offline client device 104 where it can be captured by an optical sensor of the user's client device 102 or manually entered by the user. As another example, the code may be transmitted between the offline client device 104 and the user's client device 102 using a messaging protocol, such as Bluetooth.

The client-side application 202 on the user's client device 102 uses the code to generate a substitute external authorization request and a substitute internal authorization response that includes a digital signature generated using the private key stored in the secure hardware 204 of the client device 102 that indicates user acceptance, which is transmitted to the authentication and authorization system 108 and received by the offline module 314. The offline module 314 verifies the digital signature, then generates a verification code that is delivered to client-side application 202 on the user's client device 102 which is in turn signed with a digital signature generated using the private key stored in the secure hardware 204 of the client device 102. The client-side application 202 causes the verification code to be returned to the offline client device 104. For example, the client-side application 202 may cause the verification code to be presented on a display of the client device 102, where it can be captured by an optical sensor of the offline client device 104 or entered manually by a user. The verification code may alternatively be transmitted between the client device 102 and the offline client device 104 using a communication protocol such as Bluetooth.

The offline client device 104 may verify the received verification code using a stored version of the corresponding public key. For example, the offline client device 104 may have downloaded the public key at a previous time when the offline client device 104 had internet access. Further, the offline client device 104 may have regularly requested updates on the public key to ensure that a recent copy is maintained by the offline client device 104.

FIG. 4 is a block diagram of an enrollment module 304, according to some example embodiments. To avoid obscuring the inventive subject matter with unnecessary detail, various functional components (e.g., modules) that are not germane to conveying an understanding of the inventive subject matter have been omitted from FIG. 4. However, a skilled artisan will readily recognize that various additional functional components may be supported by the enrollment module 304 to facilitate additional functionality that is not specifically described herein. Furthermore, the various functional modules depicted in FIG. 4 may reside on a single computing device or may be distributed across several computing devices in various arrangements such as those used in cloud-based architectures.

As shown, the enrollment module 304 includes a request receiving module 402, a data gathering module 404, a key creation module 406, and a data verification module 408. The enrollment module 304 facilitates the enrollment process during which a user creates a user account with the authentication and authorization system 108. The request receiving module 402 receives a request from a client device 102 to create a new account with the authentication and authorization system 108. For example, the request is received from the client-side application 202 installed on the client device 102.

The data gathering module 404 gathers data to verify the requesting user and create the new user account. For example, the data gathering module 404 prompts the user for information such as personal information (e.g., name, address, social security number, driver's license number, etc.), biometric data (e.g., fingerprint, face scan, retina scan, etc.), an image of the user, a captured image of one or more of the user's government-issued identity documents (including but not limited to a driver's license or a passport), etc. The data gathering module 404 causes the client-side application 202 to collect certain data using sensors of the client device 102. For example, an optical sensor (e.g., camera) of the client device 102 can be used to capture an image of the user, capture an image of the user's driver's license, perform a face or retina scan, etc. As another example, a biometric sensor, such as a fingerprint sensor, may be used to capture a fingerprint of the user.

The key creation module 406 generates a private/public key pair for the user account, which corresponds to the client device 102 used during the enrollment process. The public/private key pair is unique to the client device 102, rather than to the generated user account. Thus, if a user were to add another authorized client device 104 to their user account, a different public/private key pair would be generated for the added client device 104.

To generate the public/private key pair, the key creation module 406 causes the client-side application 202 on the client device 102 to instruct the secure hardware 204 to generate the private/public key pair. The private key generated by the secure hardware 204 is maintained by the secure hardware 204 on the client device 102. The public key, however, is returned to the authentication and authorization system 108. Accordingly, neither the authentication and authorization system 108 nor the client-side application 202 have direct access to the private key generated for the client device 102.

The key creation module 406 stores the public key at the authentication and authorization system 108 and associates the public key with the corresponding client device 102. In some embodiments, the key creation module 406 stores the public key in a distributed database, such as a distributed ledger, biockchain, etc.

The data verification module 408 verifies the data received from the user. For example, the data verification module 408 may communicate with third-party services (not shown) to verify the user's provided social security number, driver's license, name, address, etc. The data verification module 408 may also perform an image analysis and comparison between the image captured of the user and the image on the user's provided driver's license. This can be used to confirm that the driver's license belongs to the user that provided the image and is attempting to enroll with the authentication and authorization system 108.

The data verification module 408 may also verify that the client device 102 being used throughout the enrollment process is the same client device 102. This protects against attempts to forward communications to a different client device 102 than the client device 102 that was initially used to being the enrollment process. To accomplish this, the data verification module 408 sends a message to the client device 102 (e.g., Short Message Service (SMS) message) that includes a deep link for the client-side application 202. The deep link, when selected by a user, causes execution of the client-side application 202 on the client device 102, and causes the client-side application 202 to generate and transmit a verification message back to the authentication and authorization system 108. The verification message includes a digital signature (e.g., cryptographic signature) that was generated using the private key stored in the secure hardware 204 of the client device 102. For example, the client-side application 202 instructs the secure hardware 204 to generate the cryptographic signature, which the client-side application 202 then includes in the verification message transmitted back to the authentication and authorization system 108. The data verification module 408 uses the public key corresponding to the client device 102 to verify that the digital signature was generated using the corresponding private key, which confirms that the digital signature was generated by the same client device 102 that was used to initiate the enrollment process.

Once a user's data has been verified and the user account has been created, the enrollment module 304 may delete some or all of the data received from the user during the enrollment process. For example, the enrollment module 304 may delete any sensitive data, such as the user's social security number, copy of the user's driver's license, etc. In some embodiments, the enrollment module 304 may maintain some of the data, such as the captured image of the user, in the data storage 312. To provide additional security, the stored data may be encrypted using the public key prior to storage. Accordingly, a hacker would not be able to access the data without the corresponding private key stored in the secure storage of the client device 102. The user's sensitive data may be stored at the client device 102 in the secure hardware 204. The sensitive data may be encrypted prior to storage, for example using the private key stored in the secure hardware 204.

In some embodiments, the enrollment module 304 may maintain a hash of the user's sensitive data. The hash maintains the privacy of the user, while also being used to verify a user's sensitive data. For example, a third-party may use the same hashing algorithm to generate a hash of information provided by a user. The third-party service may then provide the hash to the authentication and authorization system 108, where it is compared to the stored hash to verify the information.

FIG. 5 is a block diagram of an authorization module 306, according to some example embodiments. To avoid obscuring the inventive subject matter with unnecessary detail, various functional components (e.g., modules) that are not germane to conveying an understanding of the inventive subject matter have been omitted from FIG. 5. However, a skilled artisan will readily recognize that various additional functional components may be supported by the authorization module 306 to facilitate additional functionality that is not specifically described herein. Furthermore, the various functional modules depicted in FIG. 5 may reside on a single computing device or may be distributed across several computing devices in various arrangements such as those used in cloud-based architectures.

As shown, the authorization module 306 includes a request receiving module 502, an authorized device identification module 504, a request transmitting module 506, a message receiving module 508, a verification module 510, and a message transmitting module 512.

The request receiving module 502 receives external authorization requests to perform a requested transaction. An external authorization request is a request for authorization to perform a specified transaction that is transmitted to the authentication and authorization system 108 from a device external to the authentication and authorization system 108 (e.g., online service 106, client devices 102, 104). For example, an external authorization request may be received from an online service 106 as a result of a user attempting to perform a transaction on the online service 106. Some transactions may be designated by the online service 106 and/or the user as requiring authorization from the user via the authentication and authorization system 108, such as logging into a user account, transferring monetary funds, purchasing an item, accessing or transferring personal information.

The external authorization request includes data describing the requested transaction and a unique identifier associated with a user account of the authentication and authorization system 108, such as the username used to log into the user's account with the authentication and authorization system 108. For example, the user may be prompted by the online service 106 to enter their username with the authentication and authorization system 108 to perform the requested transaction on the online service 106. As another example, the online service 106 may have the user's username with the authentication and authorization system 108 stored in a user profile of the user with the online service 106. The online service 106 accesses the username from the user's profile with the online service 106 when the user requests to perform the transaction and then transmits the username to the authentication and authorization system 108 as part of the external authorization request.

The authorized device identification module 504 identifies client devices 102, 104 that are authorized on the user account. A user account may include one or more authorized client devices 102, 104 that may be used by a user to authorize requested transactions. The authorized device identification module 504 uses the unique identifier included in the external authorization request to identify and access the corresponding user account from the data storage 312. The authorized device identification module 504 identifies the one or more client device 102, 104 that are authorized on the user's account from the user's account.

The request transmitting module 506 then generates and transmits an internal authorization request to the authorized client devices 102, 104. An internal authorization request is a request for a user to authorize a requested transaction that is transmitted by the authentication and authorization system 108 to client devices 102, 104 that are authorized on a user's account.

The internal authorization request causes the client devices 102, 104 to present a prompt on their respective displays that describes the requested transaction and enables the user to either select to approve or deny the requested transaction. For example, the internal authorization request causes the client-side application 202 to present a user interface on a display of the client device 102, which includes text identifying the requested transaction along with user interface elements, such as buttons, which a user may select to either approve or deny the request.

The internal authorization request may further cause the user to be prompted to enter one or more authentication factors. The authorization module 306 uses multiple authentication factors to ensure that authorization for the requested transaction is provided by the correct user (e.g., the user associated with the user account). These factors can ensure that the user providing the authorization is the correct user, rather than a hacker or other fraudulent user.

One authentication factor that may be used is a captured image of the user compared to a previously captured and verified image of the user. The user may be prompted to provide an image of him/herself during the enrollment process, which is verified by the enrollment module 304. This verified image is stored at the client device 102 and/or the authentication and authorization system 108. To provide authorization for a requested action, a user of the client device 102 is prompted by the client device 102 to pose for an image, which is captured using an optical sensor (e.g., camera) of the client device 102. The captured image is then compared to the previously captured and verified image of the user associated with the user account to ensure that the user using the client device 102 is the same user associated with the user account. For example, the client device 102 compares the captured image to the previously captured image which is stored at the client device 102. Alternatively, the captured image is transmitted by the client device 102 to the authentication and authorization system 108, and the authorization module 306 compares the captured image to the previously captured and verified image of the user that is stored by the authentication and authorization system 108.

Another authentication factor that may be used is a passcode. For example, the client device 102 prompts the user for the user's preset passcode as part of the process to authorize an internal authorization request. the presented passcode may be a code utilized by the client device 102 to log into the client device 102, or alternatively, a preset passcode set by the authentication and authorization system 108 during the enrollment process with the authentication and authorization system 108. The client device 102 denies attempts to authorize a requested transaction in the event that the correct passcode is not provided.

Another authentication factor that may be used is a biometric data item collected from the user. A biometric data item is data describing a gathered body measurement, such as a fingerprint, eye scan, etc. The client device 102 may prompt the user for a biometric data item during the process of authorizing the internal authorization request. The biometric data item is collected using a sensor of the client device 102, such as an optical sensor (e.g., camera), fingerprint scanner, etc. The collected biometric data item is compared to a previously captured and verified. version of the biometric data item to verify the identity of the user. The previously captured and verified version of the biometric data item may be a biometric data item collected and used by the client device 102 as part of the login process for the client device 102 itself, or alternatively, a biometric data item collected by the authentication and authorization system 108 during the enrollment process with the authentication and authorization system 108.

The user's selection to either approve or deny the request in turn causes the client-side application 202 to generate and transmit an internal authorization message to the authentication and authorization system 108. An internal authorization message is a message sent from an authorized client device 102, 104 to the authentication and authorization system 108 as a response to an internal authorization request. The internal authorization system indicates the user's selection to either approve or deny the requested transaction. For example, an internal authorization message may indicate that the user has selected to authorize the requested transaction or, alternatively, indicate that the user has selected to deny the requested transaction.

To further verify that the authorization is received from the correct user, the private key stored in the secure hardware 204 is used to generate a digital signature (e.g., cryptographic signature), which is included in the internal authorization message transmitted from the client device 102 to the authentication and authorization system 108. For example, the client-side application 202 instructs the secure hardware 204 to generate the digital signature, and then includes the digital signature generated by the secure hardware 204 in the internal authorization message that is transmitted to the authentication and authorization system 108.

The message receiving module 508 receives the internal authorization message from the client device 102 and the verification module 510 uses the public key corresponding to the client device 102 to verify the digital signature included in the received internal authorization message. This ensures that the internal authorization request was received from the correct client device 102, rather than the client device 102 of a hacker or other fraudulent user, and further ensures that the response to the internal authorization request has not been altered in transit.

The message transmitting module 512 transmits an external authorization message. An external authorization message is a message transmitted by the authentication and authorization system 108 to an external device as a reply to the external authorization request. The external authorization message indicates whether the requested action should be allowed or denied based on the user selection indicated in the internal authorization message received from the client device 102. For example, the message transmitting module 512 transmits the external authorization message to the online service 106 from which the external authorization request was received. The online service 106 allows or denies the requested transaction based on the user selection indicated in the external authorization message.

FIG. 6 is a block diagram of an additional device enrollment module 308, according to some example embodiments. To avoid obscuring the inventive subject matter with unnecessary detail, various functional components (e.g., modules) that are not germane to conveying an understanding of the inventive subject matter have been omitted from FIG. 6. However, a skilled artisan will readily recognize that various additional functional components may be supported by the additional device enrollment module 308 to facilitate additional functionality that is not specifically described herein. Furthermore, the various functional modules depicted in FIG. 6 may reside on a single computing device or may be distributed across several computing devices in various arrangements such as those used in cloud-based architectures.

As shown, the additional device enrollment module 308 includes a request receiving module 602, an authorization module 604, a key creation module 606, and a data transfer module 608. The additional device enrollment module 308 enables the process by which a user may add an additional client device 102 to their existing user account. A user may enroll multiple client devices 102, 104 to their user account, any of which can then be used to authorize a requested transaction.

The request receiving module 602 receives requests to enroll an additional client device 102 to an existing user account. To enroll an additional client device 102, a user initially communicates with the authentication and authorization system 108 to request to add the additional client device 102 to an existing user account of the authentication and authorization system 108. For example, the user uses the additional client device 102 the user would like to add to their user account, or alternatively a client device 104 that is already authorized on their user account. In either case, the user provides data identifying their user account and the additional client device 102 they would like added to their user account, which is included in the request received by the request receiving module 602. For example, the user may provide the phone number associated with the additional client device 102.

The authorization module 604 executes the authorization process for the requested transaction of enrolling the additional client device 102 to the existing user account. The additional device enrollment module 308 treats the request as an external authorization request to execute the requested transaction of adding the additional client device 102 to the user account. Accordingly, the authorization module 604 communicates with the authorization module 306 to execute the authorization process described above, such as transmitting an internal authorization request to a client device 104 that is already authorized on the user account, verifying a digital signature received in an internal authorization message, etc. Once authorization for the requested transaction is received, the authorization module 604 updates the user account to indicate that the additional client device 102 is now an authorized device on the user account.

The key creation module 606 generates a private/public key pair for the additional client device 102. That is, the key creation module 606 instructs the client-side application 202 installed on the additional client device 102 to communicate with the secure hardware 204 on the additional client device 102 to generate the private/public key pair. The additional client device 102 stores the private key in the secure hardware 204 of the additional client device 102 and returns the public key to the authentication and authorization system 108.

The data transfer module 608 transmits the public key for the additional client device 102 to a client device 104 that was previously authorized on the user account. The previously authorized client device 104 uses the received public key to encrypt any sensitive data stored on the previously authorized client device 104 (e.g., in the secure hardware 204 of the previously authorized client device 104). The encrypted sensitive data is then returned to the authentication and authorization system 108, and the data transfer module 608 transmits the encrypted data to the additional client device 102. The additional client device 102 can decrypt the encrypted data using the private key stored in the secure hardware 204 of the additional client device 102.

FIG. 7 is a block diagram of a data transfer module 310, according to some example embodiments. To avoid obscuring the inventive subject matter with unnecessary detail, various functional components (e.g., modules) that are not germane to conveying an understanding of the inventive subject matter have been omitted from FIG. 7. However, a skilled artisan will readily recognize that various additional functional components may be supported by the data transfer module 310 to facilitate additional functionality that is not specifically described herein. Furthermore, the various functional modules depicted in FIG. 7 may reside on a single computing device or may be distributed across several computing devices in various arrangements such as those used in cloud-based architectures.

As shown, the data transfer module 310 includes a request receiving module 702, an authorization module 704, a key transmission module 706, and an encrypted data transfer module 708. The data transfer module 310 facilitates the secure transfer of sensitive data to a requesting party. One requested action may be the transfer of a user's sensitive data to another person or entity. For example, a banking institution may request the sensitive data as part of processing a loan application, credit card application, etc.

The request receiving module 702 receives an external authorization request to transfer a user's sensitive data to a recipient.

The authorization module 704 communicates with the authorization module 306 to execute the authorization process, such as transmitting an internal authorization request to client devices 102, 104 already authorized on the user account, verifying a digital signature received in an internal authorization message, etc.

The key transmission module 706 transmits a public key associated with the requesting party to an authorized client device 102 of the user. This public key may be included in the internal authorization request or transmitted after authorization for the requested transaction is received. The authorized client device 102 uses the public key to encrypt the requested sensitive data stored in the secure hardware of the client device 102. The client device 102 returns the encrypted sensitive data to the authentication and authorization system 108, which is received by the encrypted data transfer module 708. The data transfer module 708 transfers the encrypted data to a client device 104 of the requesting party. The requesting party may decrypt the encrypted sensitive data using their private key. After transferring the encrypted sensitive data to the requesting party, the encrypted data transfer module 708 may delete the encrypted sensitive data received by the authentication and authorization system 108 from the client device 102.

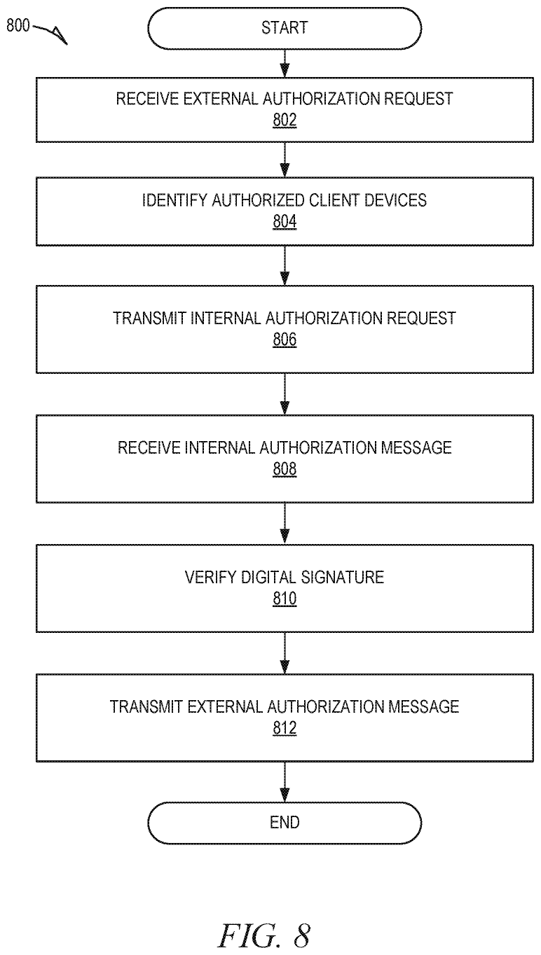

FIG. 8 is flowchart showing an example method 800 of authorizing transactions based on a private key stored in secure hardware on an authorized client device, according to certain example embodiments. The method 800 may be embodied in computer-readable instructions for execution by one or more processors such that the operations of the method 800 may be performed in part or in whole by the authorization module 306; accordingly, the method 800 is described below by way of example with reference thereto. However, it shall be appreciated that at least some of the operations of the method 800 may be deployed on various other hardware configurations and the method 800 is not intended to be limited to the authorization module 306.

At operation 802, the request receiving module 502 receives an external authorization request. An external authorization request is a request for authorization to perform a specified transaction that is transmitted to the authentication and authorization system 108 from a device external to the authentication and authorization system 108 (e.g., online service 106, client devices 102, 104). For example, an external authorization request may be received from an online service 106 as a result of a user attempting to perform a transaction on the online service 106. Some transactions may be designated by the online service 106 and/or the user as requiring authorization from the user via the authentication and authorization system 108, such as logging into a user account, transferring monetary funds, purchasing an item, accessing or transferring personal information.

The external authorization request includes data describing the requested transaction and a unique identifier associated with a user account of the authentication and authorization system 108, such as the username used to log into the user's account with the authentication and authorization system 108. For example, the user may be prompted by the online service 106 to enter their username with the authentication and authorization system 108 to perform the requested transaction on the online service 106. As another example, the online service 106 may have the user's username with the authentication and authorization system 108 stored in a user profile of the user with the online service 106. The online service 106 accesses the username from the user's profile with the online service 106 when the user requests to perform the transaction and then transmits the username to the authentication and authorization system 108 as part of the external authorization request.

At operation 804, the authorized device identification module 504 identifies authorized client devices 102, 104. A user account may include one or more authorized client devices 102, 104 that may be used by a user to authorize requested transactions. The authorized device identification module 504 uses the unique identifier included in the external authorization request to identify and access the corresponding user account from the data storage 312. The authorized device identification module 504 identifies the one or more client device 102, 104 that are authorized on the user's account from the user's account.

At operation 806, the request transmitting module 506 transmits an internal authorization request. The request transmitting module 506 transmits the internal authorization request to the authorized client devices 102, 104. An internal authorization request is a request for a user to authorize a requested transaction that is transmitted by the authentication and authorization system 108 to client devices 102, 104 that are authorized on a user's account.

The internal authorization request causes the client devices 102, 104 to present a prompt on their respective displays that describes the requested transaction and enables the user to either select to approve or deny the requested transaction. For example, the internal authorization request causes the client-side application 202 to present a user interface on a display of the client device 102, which includes text identifying the requested transaction along with user interface elements, such as buttons, which a user may select to either approve or deny the request.

The internal authorization request may further cause the user to be prompted to enter one or more authentication factors. The authorization module 306 uses multiple authentication factors to ensure that authorization for the requested transaction is provided by the correct user (e.g., the user associated with the user account). These factors can ensure that the user providing the authorization is the correct user, rather than a hacker or other fraudulent user.

One authentication factor that may be used is a captured image of the user compared to a previously captured and verified image of the user. The user may be prompted to provide an image of him/herself during the enrollment process, which is verified by the enrollment module 304. This verified image is stored at the client device 102 and/or the authentication and authorization system 108. To provide authorization for a requested action, a user of the client device 102 is prompted by the client device 102 to pose for an image, which is captured using an optical sensor (e.g., camera) of the client device 102. The captured image is then compared to the previously captured and verified image of the user associated with the user account to ensure that the user using the client device 102 is the same user associated with the user account. For example, the client device 102 compares the captured image to the previously captured image which is stored at the client device 102. Alternatively, the captured image is transmitted by the client device 102 to the authentication and authorization system 108 and the authorization module 306 compares the captured image to the previously captured and verified image of the user that is stored by the authentication and authorization system 108.

Another authentication factor that may be used is a passcode. For example, the client device 102 prompts the user for the user's preset passcode as part of the process to authorize an internal authorization request. The presented passcode may be a code utilized by the client device 102 to log into the client device 102, or alternatively, a preset passcode set by the authentication and authorization system 108 during the enrollment process with the authentication and authorization system 108. The client device 102 denies attempts to authorize a requested transaction in the event that the correct passcode is not provided.

Another authentication factor that may be used is a biometric data item collected from the user. A biometric data item is data describing a gathered body measurement, such as a fingerprint, eye scan, etc. The client device 102 may prompt the user for a biometric data item during the process of authorizing the internal authorization request. The biometric data item is collected using a sensor of the client device 102, such as an optical sensor (e.g., camera), fingerprint scanner, etc. The collected biometric data item is compared to a previously captured and verified version of the biometric data item to verify the identity of the user. The previously captured and verified version of the biometric data item may be a biometric data item collected and used by the client device 102 as part of the login process for the client device 102 itself, or alternatively, a biometric data item collected by the authentication and authorization system 108 during the enrollment process with the authentication and authorization system 108.

The user's selection to either approve or deny the request in turn causes the client-side application 202 to generate and transmit an internal authorization message to the authentication and authorization system 108. An internal authorization message is a message sent from an authorized client device 102, 104 to the authentication and authorization system 108 as a response to an internal authorization request. The internal authorization system indicates the user's selection to either approve or deny the requested transaction. For example, an internal authorization message may indicate that the user has selected to authorize the requested transaction or, alternatively, indicate that the user has selected to deny the requested transaction.

To further verify that the authorization is received from the correct user, the private key stored in the secure hardware 204 is used to generate a digital signature (e.g., cryptographic signature), which is included in the internal authorization message transmitted from the client device 102 to the authentication and authorization system 108. For example, the client-side application 202 instructs the secure hardware 204 to generate the digital signature, and then includes the digital signature generated by the secure hardware 204 in the internal authorization message that is transmitted to the authentication and authorization system 108.

At operation 808, the message receiving module 508 receives an internal authorization message. The message receiving module 508 receives the internal authorization message from the client device 102.

At operation 810, the verification module 510 verifies the digital signature. The verification module 510 uses the public key corresponding to the client device 102 to verify the digital signature included in the received internal authorization message. This ensures that the internal authorization request was received from the correct client device 102, rather than the client device 102 of a hacker or other fraudulent user, and further ensures that the response to the internal authorization request has not been altered in transit.

At operation 812, the message transmitting module 512 transmits an external authorization message. An external authorization message is a message transmitted by the authentication and authorization system 108 to an external device as a reply to the external authorization request. The external authorization message indicates whether the requested action should be allowed or denied based on the user selection indicated in the internal authorization message received from the client device 102. For example, the message transmitting module 512 transmits the external authorization message to the online service 106 from which the external authorization request was received. The online service 106 allows or denies the requested transaction based on the user selection indicated in the external authorization message.

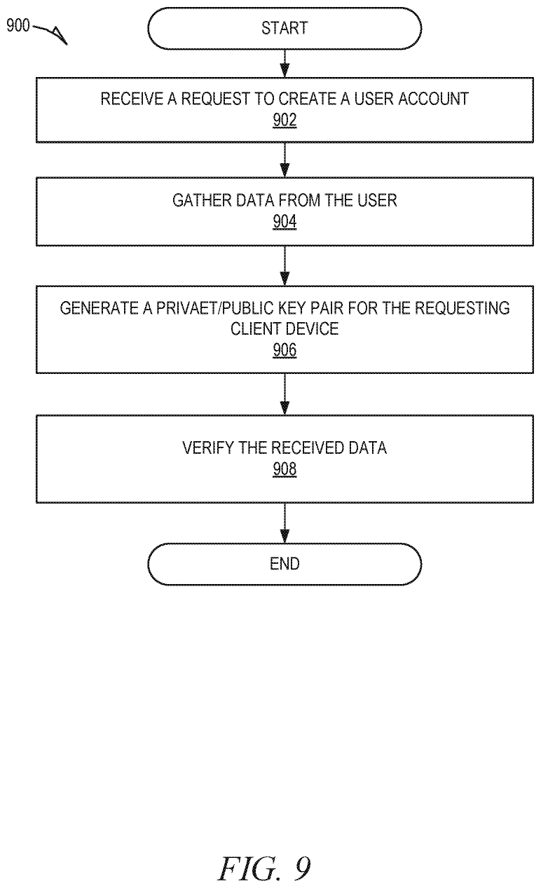

FIG. 9 is flowchart showing an example method 900 of enrolling a user account with the authorization system, according to certain example embodiments. The method 900 may be embodied in computer-readable instructions for execution by one or more processors such that the operations of the method 900 may be performed in part or in whole by the enrollment module 304; accordingly, the method 900 is described below by way of example with reference thereto. However, it shall be appreciated that at least some of the operations of the method 900 may be deployed on various other hardware configurations and the method 900 is not intended to be limited to the enrollment module 304.

At operation 902, the request receiving module 402 receives a request to create a user account. The request receiving module 402 receives the request from a client device 102 to create a new account with the authentication and authorization system 108. For example, the request is received from the client-side application 202 installed on the client device 102.

At operation 904, the data gathering module 404 gathers data from the user. The data gathering module 404 gathers data to verify the requesting user and create the new user account. For example, the data gathering module 404 prompts the user for information such as personal information (e.g., name, address, social security number, driver's license number, etc.), biometric data (e.g., fingerprint, face scan, retina scan, etc.), an image of the user, a captured image of one or more of the user's government-issued identity documents (including but not limited to a driver's license or a passport), etc. The data gathering module 404 causes the client-side application 202 to collect certain data using sensors of the client device 102. For example, an optical sensor (e.g., camera) of the client device 102 can be used to capture an image of the user, capture an image of the user's driver's license, perform a face or retina scan, etc. As another example, a biometric sensor, such as a fingerprint sensor, may be used to capture a fingerprint of the user.

At operation 906, the key creation module 406 generates a private/public key pair for the requesting client device 102. The public/private key pair is unique to the client device 102, rather than to the generated user account. Thus, if a user were to add another authorized client device 104 to their user account, a different public/private key pair would be generated for the added client device 104.

To generate the public/private key pair, the key creation module 406 causes the client-side application 202 on the client device 102 to instruct the secure hardware 204 to generate the private/public key pair. The private key generated by the secure hardware 204 is maintained by the secure hardware 204 on the client device 102. The public key, however, is returned to the authentication and authorization system 108. Accordingly, neither the authentication and authorization system 108 nor the client-side application 202 has direct access to the private key generated for the client device 102.

The key creation module 406 stores the public key at the authentication and authorization system 108 and associates the public key with the corresponding client device 102. In some embodiments, the key creation module 406 may store the public key in a distributed database, such as a distributed ledger, blockchain, etc.

At operation 908, the data verification module 408 verifies the received data. For example, the data verification module 408 may communicate with third-party services (not shown) to verify the user's provided social security number, driver's license, name, address, etc. The data verification module 408 may also perform an image analysis and comparison between the image captured of the user and the image on the user's provided driver's license. This can be used to confirm that the driver's license belongs to the user that provided the image and is attempting to enroll with the authentication and authorization system 108. In some embodiments, operation 908 is performed prior to 906 in which the key creation module 406 generates a private/public key pair for the requesting client device 102

The data verification module 408 may also verify that the client device 102 being used throughout the enrollment process is the same client device 102. This protects against attempts to forward communications to a different client device 102 than the client device 102 that was initially used to being the enrollment process. To accomplish this, the data verification module 408 sends a message to the client device 102 (e.g., Short Message Service (SMS) message) that includes a deep link for the client-side application 202. The deep link, when selected by a user, causes execution of the client-side application 202 on the client device 102, and causes the client-side application 202 to generate and transmit a verification message back to the authentication and authorization system 108. The verification message includes a digital signature (e.g., cryptographic signature) that was generated using the private key stored in the secure hardware 204 of the client device 102. For example, the client-side application 202 instructs the secure hardware 204 to generate the cryptographic signature, which the client-side application 202 then includes in the verification message transmitted back to the authentication and authorization system 108. The data verification module 408 uses the public key corresponding to the client device 102 to verify that the digital signature was generated using the corresponding private key, which confirms that the digital signature was generated by the same client device 102 that was used to initiate the enrollment process.

Once a user's data has been verified and the user account has been created, the enrollment module 304 may delete some or all of the data received from the user during the enrollment process. For example, the enrollment module 304 may delete any sensitive data, such as the user's social security number, copy of the user's driver's license, etc. In some embodiments, the enrollment module 304 may maintain some of the data, such as the captured image of the user, in the data storage 312. To provide additional security, the stored data may be encrypted using the public key prior to storage. Accordingly, a hacker would not be able to access the data without the corresponding private key stored in the secure storage of the client device 102. The user's sensitive data may he stored at the client device 102 in the secure hardware 204. The sensitive data may be encrypted prior to storage, for example using the private key stored in the secure hardware 204.

In some embodiments, the enrollment module 304 may maintain a hash of the user's sensitive data. The hash maintains the privacy of the user, while also being used to verify a user's sensitive data. For example, a third-party may use the same hashing algorithm to generate a hash of information provided by a user. The third-party service may then provide the hash to the authentication and authorization system 108, where it is compared to the stored hash to verify the information.

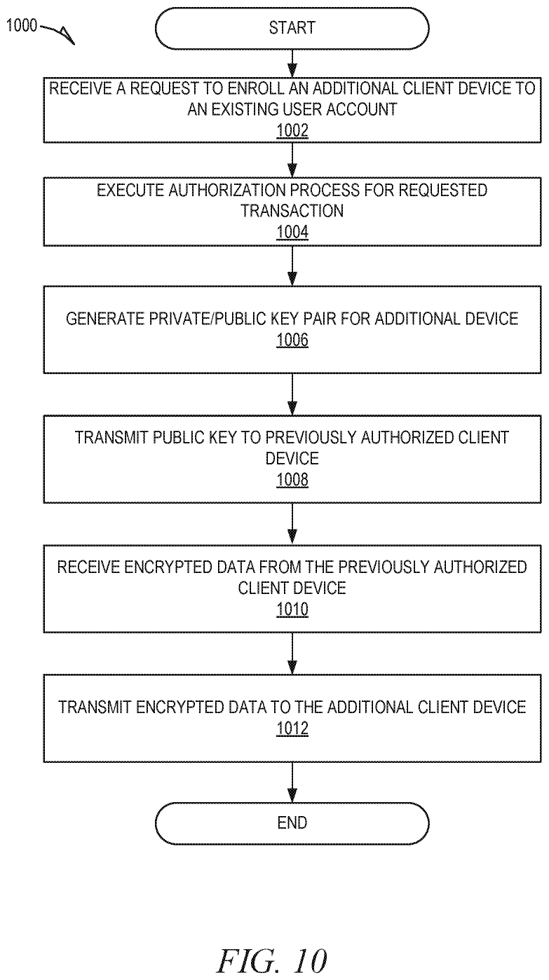

FIG. 10 is flowchart showing an example method 1000 for enrolling an addition device to an existing user account of an authorization system, according to certain example embodiments. The method 1000 may be embodied in computer-readable instructions for execution by one or more processors such that the operations of the method 1000 may be performed in part or in whole by the additional device enrollment module 308; accordingly, the method 1000 is described below by way of example with reference thereto. However, it shall be appreciated that at least some of the operations of the method 1000 may be deployed. on various other hardware configurations and the method 1000 is not intended to be limited to the additional device enrollment module 308.

At operation 1002, the request receiving module 602 receives a request to enroll an additional client device 102 to an existing user account. To enroll an additional client device 102, a user initially uses a client device 102 to communicate with the authentication and authorization system 108 to request to add the additional client device 102 to an existing user account of the authentication and authorization system 108. For example, the user uses the additional client device 102 the user would like to add to their user account, or alternatively a client device 104 that is already authorized on their user account. In either case, the user provides data identifying their user account and the additional client device 102 they would like added to their user account, which is included in the request received by the request receiving module 602. For example, the user may provide the phone number associated with the additional client device 102.

At operation 1004, the authorization module 604 executes an authorization process for the requested transaction. The additional device enrollment module 308 treats the request as an external authorization request to execute the requested transaction of adding the additional client device 102 to the user account. Accordingly, the authorization module 604 communicates with the authorization module 306 to execute the authorization process described above, such as transmitting an internal authorization request to a client device 104 that is already authorized on the user account, verifying a digital signature received in an internal authorization message, etc. Once authorization for the requested transaction is received, the authorization module 604 updates the user account to indicate that the additional client device 102 is now an authorized device on the user account.

At operation 1006, the key creation module 606 generates a private/public key pair for the additional device. That is, the key creation module 606 instructs the client-side application 202 installed on the additional client device 102 to communicate with the secure hardware 204 on the additional client device 102 to generate the private/public key pair. The additional client device 102 stores the private key in the secure hardware 204 of the additional client device 102 and returns the public key to the authentication and authorization system 108.

At operation 1008, the data transfer module 608 transmits the public key to a previously authorized client device 104.

At operation 1010, the data transfer module 608 receives encrypted data from the previously authorized client device 104. The previously authorized client device 104 uses the received public key to encrypt any sensitive data stored on the previously authorized client device 104 (e.g., in the secure hardware 204 of the previously authorized client device 104). The encrypted sensitive data is then returned to the authentication and authorization system 108.

At operation 1012, the data transfer module 608 transmits the encrypted data to the additional client device 102. The additional client device 102 can decrypt the encrypted data using the private key stored in the secure hardware 204 of the additional client device 102.

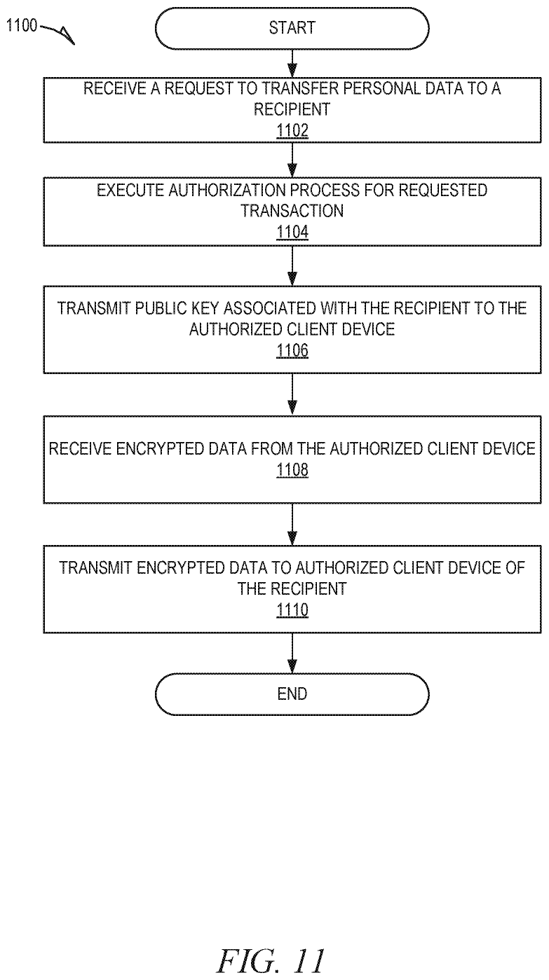

FIG. 11 is flowchart showing an example method 1100 of securely transferring private data using the authorization system, according to certain example embodiments. The method 1100 may be embodied in computer-readable instructions for execution by one or more processors such that the operations of the method 1100 may be performed in part or in whole by the data transfer module 310; accordingly, the method 1100 is described below by way of example with reference thereto. However, it shall be appreciated that at least some of the operations of the method 1100 may be deployed on various other hardware configurations and the method 1100 is not intended to be limited to the data transfer module 310.

At operation 1102, the request receiving module 702 receives a request to transfer sensitive data to a recipient. For example, the request receiving module 702 receives an external authorization request to transfer a user's sensitive data to a recipient.

At operation 1104, the authorization module 704 executes the authorization process for the requested transaction. For example, the authorization module 704 communicates with the authorization module 306 to execute the authorization process, such as transmitting an internal authorization request to client devices 102, 104 already authorized on the user account, verifying a digital signature received in an internal authorization message, etc.

The key transmission module 706 transmits a public key associated with the recipient to the authorized client device 102. This public key may be included in the internal authorization request or transmitted after authorization for the requested transaction is received. The authorized client device 102 uses the public key to encrypt the requested sensitive data stored in the secure hardware of the client device 102. The client device 102 returns the encrypted sensitive data to the authentication and authorization system 108, which, at operation 1108, is received by the encrypted data transfer module 708.

At operation 1110, the encrypted data transfer module 708 transmits the encrypted data to an authorized client device 104 of the recipient. The requesting party may decrypt the encrypted sensitive data using their private key. After transferring the encrypted sensitive data to the requesting party, the encrypted data transfer module 708 may delete the encrypted sensitive data received by the authentication and authorization system 108 from the client device 102.

### EXAMPLES

Example 1 is a method comprising: receiving, by an authorization system, an external authorization request from a remote server, the external authorization request including a unique identifier for a user account of the authorization system and the external authorization request including data identifying a requested action; transmitting, to a client device associated with the user account, an internal authorization request, the internal authorization request including the data. identifying the requested action and the internal authorization request causing the client device to perform operations comprising presenting a prompt to authorize the requested action; receiving, from the client device, an internal authorization message in response to the internal authorization request, the internal authorization message indicating that the requested action has been authorized, the internal authorization message including a digital signature that was generated by the client device using a private key stored in a secure hardware of the client device; in response to receiving the internal authorization message, verifying the digital signature using a public key associated with the user account; and in response to verifying the digital signature, transmitting an external authorization message to the remote server, the external authorization message authorizing execution of the requested action.

In Example 2, the subject matter of Example 1 optionally includes wherein the internal authorization request further causes the client device to perform operation comprising: capturing an image of a user using the client device; comparing the image of the user using the client device to a verified image of the user associated with the user account, the verified image stored in the secure hardware of the client device and having been captured by the client device during an enrollment process with the authorization system; and determining, based on comparing the image of the user using the client device to the verified image of the user associated with the user account, that the user using the client device is the user associated with the user account.

Example 3, the subject matter of Example 1 or Example 2 optionally includes receiving, from the client device, an image of a user using the client device; comparing the image of the user using the client device to a verified image of the user associated with the user account, the verified image having been received from the client device during an enrollment process with the authorization system; and determining, based on comparing the image of the user using the client device to the verified image of the user associated with the user account, that the user using the client device is the user associated with the user account.

In Example 4, the subject matter of Examples 1 to 3 optionally includes wherein the internal authorization request further causes the client device to perform operation comprising: presenting a prompt to enter a passcode and a biometric data item; receiving the passcode and biometric data item from a user using the client device; and verifying the user using the client device based on the passcode and biometric data item.

In Example 5, the subject matter of Example, 1 to 4 optionally includes accessing the public key associated with the user account from a distributed database.

In Example 6, the subject matter of Examples 1 to 5 optionally includes wherein the requested action is transmitting personal information associated with the user account to a recipient, the method further comprising: transmitting, to the client device, a public key associated with a user account of the recipient; receiving, from the client device, encrypted personal information, the personal information having been encrypted by the client device using the public key associated with the user account of the recipient; and transmitting the encrypted personal information to a second client device associated with the user account of the recipient, the second client device maintaining a private key to decrypt the encrypted personal information.

In Example 7, the subject matter of Examples 1 to 6 optionally includes wherein the internal authorization request is a deep link that causes the client device to execute a client-side application associated with the authorization system, the client-side application generating the internal authorization message and causing transmission of the internal authorization message back to the authorization system.

Example 8 is an authorization system comprising: one or more computer processors; and one or more computer-readable mediums storing instructions that, when executed by the one or more computer processors, cause the authorization system to perform operations comprising: receiving an external authorization request from a remote server, the external authorization request including a unique identifier for a user account of the authorization system and the external authorization request including data identifying a requested action; transmitting, to a client device associated with the user account, an internal authorization request, the internal authorization request including the data identifying the requested action and the internal authorization request causing the client device to perform operations comprising presenting a prompt to authorize the requested action; receiving, from the client device, an internal authorization message in response to the internal authorization request, the internal authorization message indicating that the requested action has been authorized, the internal authorization message including a digital signature that was generated by the client device using a private key stored in a secure hardware of the client device; in response to receiving the internal authorization message, verifying the digital signature using a public key associated with the user account; and in response to verifying the digital signature, transmitting an external authorization message to the remote server, the external authorization message authorizing execution of the requested action.

In Example 9, the subject matter of Example 8 optionally includes wherein the internal verification request further causes the client device to perform operation comprising: capturing an image of a user using the client device; comparing the image of the user using the client device to a verified image of the user associated with the user account, the verified image stored in the secure hardware of the client device and having been captured by the client device during an enrollment process with the authorization system; and determining, based on comparing the image of the user using the client device to the verified image of the user associated with the user account, that the user using the client device is the user associated with the user account.

In Example 10, the subject matter of Example 8 or Example 9 optionally includes receiving, from the client device, an image of a user using the client device; comparing the image of the user using the client device to a verified image of the user associated with the user account, the verified image having been received from the client device during an enrollment process with the authorization system; and determining, based on comparing the image of the user using the client device to the verified image of the user associated with the user account, that the user using the client device is the user associated with the user account.

In Example 11, the subject matter of Examples 8 to 10 optionally includes wherein the internal authorization request further causes the client device to perform operation comprising: presenting a prompt to enter a passcode and a biometric data item; receiving the passcode and biometric data item from a user using the client device; and verifying the user using the client device based on the passcode and biometric data item.

In Example 12, the subject matter of Examples 8 to 11 optionally includes accessing the public key associated with the user account from a distributed database.

In Example 13, the subject matter of Examples 8 to 12 optionally includes wherein the requested action is transmitting personal information associated with the user account to a recipient, the operations further comprising: transmitting, to the client device, a public key associated with a user account of the recipient; receiving, from the client device, encrypted personal information, the personal information having been encrypted by the client device using the public key associated with the user account of the recipient; and transmitting the encrypted personal information to a second client device associated with the user account of the recipient, the second client device maintaining a private key to decrypt the encrypted personal information.

In Example 14, the subject matter of Examples 8 to 13 optionally includes wherein the internal authorization request is a deep link that causes the client device to execute a client-side application associated with the authorization system, the client-side application generating the internal authorization message and causing transmission of the internal authorization message back to the authorization system.

Example 15 is non-transitory computer-readable medium storing instructions that, when executed by one or more computer processors of an authorization system, cause the authorization system to perform operations comprising: receiving an external authorization request from a remote server, the external authorization request including a unique identifier for a user account of the authorization system and the external authorization request including data identifying a requested action; transmitting, to a client device associated with the user account, an internal authorization request, the internal authorization request including the data identifying the requested action and the internal authorization request causing the client device to perform operations comprising presenting a prompt to authorize the requested action; receiving, from the client device, an internal authorization message in response to the internal authorization request, the internal authorization message indicating that the requested action has been authorized, the internal authorization message including a digital signature that was generated by the client device using a private key stored in a secure hardware of the client device; in response to receiving the internal authorization message, verifying the digital signature using a public key associated with the user account; and in response to verifying the digital signature, transmitting an external authorization message to the remote server, the external authorization message authorizing execution of the requested action.

In Example 16, the subject matter of Example 15 optionally includes wherein the internal authorization request further causes the client device to perform operation comprising: capturing an image of a user using the client device; comparing the image of the user using the client device to a verified image of the user associated with the user account, the verified image stored in the secure hardware of the client device and having been captured by the client device during an enrollment process with the authorization system; and determining, based on comparing the image of the user using the client device to the verified image of the user associated with the user account, that the user using the client device is the user associated with the user account. In Example 17, the subject matter of Example 15 or Example 16 optionally includes receiving, from the client device, an image of a user using the client device; comparing the image of the user using the client device to a verified image of the user associated with the user account, the verified image having been received from the client device during an enrollment process with the authorization system; and determining, based on comparing the image of the user using the client device to the verified image of the user associated with the user account, that the user using the client device is the user associated with the user account.

In Example 18, the subject matter of Examples 15 to 17 optionally includes wherein the internal authorization request further causes the client device to perform operation comprising: presenting a prompt to enter a passcode and a biometric data item; receiving the passcode and biometric data item from a user using the client device; and verifying the user using the client device based on the passcode and biometric data item.

In Example 19, the subject matter of Examples 15 to 18 optionally includes accessing the public key associated with the user account from a distributed database.

In Example 20, the subject matter of Examples 15 to 19 optionally includes wherein the requested action is transmitting personal information associated with the user account to a recipient, the operations further comprising: transmitting, to the client device, a public key associated with a user account of the recipient; receiving, from the client device, encrypted personal information, the personal information having been encrypted by the client device using the public key associated with the user account of the recipient; and transmitting the encrypted personal information to a second client device associated with the user account of the recipient, the second client device maintaining a private key to decrypt the encrypted personal information.

### Modules, Components And Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented. mechanically or electronically. For example, a hardware module may comprise dedicated circuitry or logic that is permanently configured (e.g., as a special-purpose processor, such as a field-programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Machine Architecture

FIG. 12 is a diagrammatic representation of a machine in the example form of a computer system 1200 within which a set of instructions for causing the machine to perform any one or more of the methodologies discussed herein may be executed. The computer system 1200 may include instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment.

The machine may, for example, be a PC, a PDA, a cellular telephone, a smart phone (e.g., iPhone®), a tablet computer, a web appliance, a handheld computer, a desktop computer, a laptop or netbook, a set-top box (STB) such as provided by cable or satellite content providers, a wearable computing device such as glasses or a wristwatch, a multimedia device embedded in an automobile, a Global Positioning System (GPS) device, a data enabled book reader, a video game system console, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU), or both), a main memory 1204, and a static memory 1206, which communicate with each other via a bus 1208. The computer system 1200 may further include a video display 1210 (e.g., a liquid crystal display (LCD) or a cathode ray tube (CRT)). The computer system 1200 also includes one or more input/output (I/O) devices 1212, a location component 1214, a drive unit 1216, a signal generation device 1218 (e.g., a speaker), and a network interface device 1220. The I/O devices 1212 may, for example, include a keyboard, a mouse, a keypad, a multi-touch surface (e.g., a touchscreen or track pad), a microphone, a camera, and the like.

The location component 1214 may be used for determining a location of the computer system 1200. In some embodiments, the location component 1214 may correspond to a GPS transceiver that may make use of the network interface device 1220 to communicate GPS signals with a GPS satellite. The location component 1214 may also be configured to determine a location of the computer system 1200 by using an internee protocol (IP) address lookup or by triangulating a position based on nearby mobile communications towers. The location component 1214 may be further configured to store a user-defined location in main memory 1204 or static memory 1206. In some embodiments, a mobile location enabled application may work in conjunction with the location component 1214 and the network interface device 1220 to transmit the location of the computer system 1200 to an application server or third-party server for the purpose of identifying the location of a user operating the computer system 1200.

In some embodiments, the network interface device 1220 may correspond to a transceiver and antenna. The transceiver may be configured to both transmit and receive cellular network signals, wireless data signals, or other types of signals via the antenna, depending on the nature of the computer system 1200.

### Machine-Readable Medium

The drive unit 1216 includes a machine-readable medium 1222 on which is stored one or more sets of data structures and instructions 1224 (e.g., software) embodying or used by any one or more of the methodologies or functions described herein. The instructions 1224 may also reside, completely or at least partially, within the main memory 1204, the static memory 1206, and/or the processor 1202 during execution thereof by the computer system 1200, with the main memory 1204, the static memory 1206, and the processor 1202 also constituting machine-readable media.

Consistent with some embodiments, the instructions 1224 may relate to the operations of an operating system (OS). Depending on the particular type of the computer system 1200, the OS may, for example, be the iOS® operating system, the Android® operating system, a BlackBerry® operating system, the Microsoft® Windows® Phone operating system, Symbian® OS, or webOS®. Further, the instructions 1224 may relate to operations performed by applications (commonly known as “apps”), consistent with some embodiments. One example of such an application is a mobile browser application that displays content, such as a web page or a user interface using a browser.

While the machine-readable medium 1222 is shown in an example embodiment to be a single medium, the term “machine-readable medium” may include a single medium or multiple media (e.g., a centralized or distributed database, and/or associated caches and servers) that store the one or more data structures or instructions 1224. The term “machine-readable medium” shall also be taken to include any tangible medium that is capable of storing, encoding, or carrying instructions (e.g._{;} instructions 1224) for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

Furthermore, the tangible machine-readable medium is non-transitory in that it does not embody a propagating signal. However, labeling the tangible machine-readable medium “non-transitory” should not be construed to mean that the medium is incapable of movement—the medium should be considered as being transportable from one real-world location to another. Additionally, since the machine-readable medium is tangible, the medium may be considered to be a machine-readable device.

### Transmission Medium

The instructions 1224 may further be transmitted or received over a network 1226 using a transmission medium. The instructions 1224 may be transmitted using the network interface device 1220 and any one of a number of well-known transfer protocols (e.g., HTTP). Examples of communication networks include a LAN, a WAN, the Internet, mobile telephone networks, plain old telephone service (POTS) networks, and wireless data networks (e.g., Wi-Fi and WiMax networks). The term “transmission medium” shall be taken to include any intangible medium that is capable of storing, encoding, or carrying the instructions 1224 for execution by the machine, and includes digital or analog communications signals or other intangible media to facilitate communication of such software.

In the present description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls. In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

What is claimed is:

1. A method comprising:
receiving, by an authorization system via a network, an external authorization request from a remote server, the external authorization request including a unique identifier for a user account of the authorization system and the external authorization request including data identifying a requested action;
transmitting, via the network to a client device associated with the user account, an internal authorization request, the internal authorization request including the data identifying the requested action and the internal authorization request causing the client device to perform operations comprising presenting a prompt to authorize the requested action;
receiving, via the network from the client device_{;} an internal authorization message in response to the internal authorization request, the internal authorization message indicating that the requested action has been authorized, the internal authorization message including a digital signature that was generated by the client device using a private key stored in a secure hardware of the client device;
in response to receiving the internal authorization message, verifying the digital signature using a public key associated with the user account; and
in response to verifying the digital signature, transmitting an external authorization message to the remote server via the network, the external authorization message authorizing execution of the requested action.

2. The method of claim 1, wherein the internal authorization request further causes the client device to perform in operation comprising:
capturing an image of a user using the client device;
comparing the image of the user using the client device to a verified image of the user associated with the user account, the verified image stored in the secure hardware of the client device and having been captured by the client device during an enrollment process with the authorization system; and
determining, based on comparing the image of the user using the client device to the verified image of the user associated with the user account, that the user using the client device is the user associated with the user account.

3. The method of claim 1, further comprising:
receiving, from the client device, an image of a user using the client device;
comparing the image of the user using the client device to a verified image of the user associated with the user account, the verified image having been received from the client device during an enrollment process with the authorization system; and
determining, based on comparing the image of the user using the client device to the verified image of the user associated with the user account, that the user using the client device is the user associated with the user account.

4. The method of claim 1, wherein the internal authorization request further causes the client device to perform operations comprising:
presenting a prompt to enter a passcode and a biometric data item;
receiving the passcode and biometric data item from a user using the client device; and
verifying the user using the client device based on the passcode and biometric data item.

5. The method of claim 1, further comprising:
accessing the public key associated with the user account from a distributed database.

6. The method of claim 1, wherein the requested action is transmitting personal information associated with the user account to a recipient, the method further comprising:
transmitting, to the client device, a public key associated with a user account of the recipient;
receiving, from the client device, encrypted personal information, the personal information having been encrypted by the client device using the public key associated with the user account of the recipient; and
transmitting the encrypted personal information to a second client device associated with the user account of the recipient, the second client device maintaining a private key to decrypt the encrypted personal information.

7. The method of claim 1, wherein the internal authorization request is a deep link that causes the client device to execute a client-side application associated with the authorization system, the client-side application generating the internal authorization message and causing transmission of the internal authorization message back to the authorization system.

8. An authorization system comprising:
one or more computer processors; and
one or more computer-readable mediums storing instructions that, when executed by the one or more computer processors, cause the authorization system to perform operations comprising:
receiving an external authorization request from a remote server, the external authorization request including a unique identifier for a user account of the authorization system and the external authorization request including data identifying a requested action;
transmitting, to a client device associated with the user account, an internal authorization request, the internal authorization request including the data identifying the requested action and the internal authorization request causing the client device to perform operations comprising presenting a prompt to authorize the requested action;
receiving, from the client device, an internal authorization message in response to the internal authorization request, the internal authorization message indicating that the requested action has been authorized, the internal authorization message including a digital signature that was generated by the client device using a private key stored in a secure hardware of the client device;
in response to receiving the internal authorization message, verifying the digital signature using a public key associated with the user account; and
in response to verifying the digital signature, transmitting an external authorization message to the remote server, the external authorization message authorizing execution of the requested action.

9. The authorization system of claim 8, wherein the internal authorization request further causes the client device to perform operations comprising:
capturing an image of a user using the client device;
comparing the image of the user using the client device to a verified image of the user associated with the user account, the verified image stored in the secure hardware of the client device and having been captured by the client device during an enrollment process with the authorization system; and
determining, based on comparing the image of the user using the client device to the verified image of the user associated with the user account, that the user using the client device is the user associated with the user account.

10. The authorization system of claim 8, the operations further comprising:
receiving, from the client device, an image of a user using the client device;
comparing the image of the user using the client device to a verified image of the user associated with the user account, the verified image having been received from the client device during an enrollment process with the authorization system; and
determining, based on comparing the image of the user using the client device to the verified image of the user associated with the user account, that the user using the client device is the user associated with the user account.

11. The authorization system of claim 8, wherein the internal authorization request further causes the client device to perform operation comprising:
presenting a prompt to enter a passcode and a biometric data item;
receiving the passcode and biometric data item from a user using the client device; and
verifying the user using the client device based on the passcode and biometric data item.

12. The authorization system of claim 8, the operations further comprising:
accessing the public key associated with the user account from a distributed database.

13. The authorization system of claim 8, wherein the requested action is transmitting personal information associated with the user account to a recipient, the operations further comprising:
transmitting, to the client device, a public key associated with a user account of the recipient;
receiving, from the client device_{;} encrypted personal information, the personal information having been encrypted by the client device using the public key associated with the user account of the recipient; and
transmitting the encrypted personal information to a second client device associated with the user account of the recipient, the second client device maintaining a private key to decrypt the encrypted personal information.

14. The authorization system of claim 8, wherein the internal authorization request is a deep link that causes the client device to execute a client-side application associated with the authorization system, the client-side application generating the internal authorization message and causing transmission of the internal authorization message back to the authorization system.

15. A non-transitory computer-readable medium storing instructions that, when executed by one or more computer processors of an authorization system, cause the authorization system to perform operations comprising:
receiving an external authorization request from a remote server, the external authorization request including a unique identifier for a user account of the authorization system and the external authorization request including data identifying a requested action;
transmitting, to a client device associated with the user account, an internal authorization request, the internal authorization request including the data. identifying the requested action and the internal authorization request causing the client device to perform operations comprising presenting a prompt to authorize the requested action;
receiving, from the client device, an internal authorization message in response to the internal authorization request, the internal authorization message indicating that the requested action has been authorized, the internal authorization message including a digital signature that was generated by the client device using a private key stored in a secure hardware of the client device;
in response to receiving the internal authorization message, verifying the digital signature using a public key associated with the user account; and
in response to verifying the digital signature, transmitting an external authorization message to the remote server, the external authorization message authorizing execution of the requested action.

16. The non-transitory computer-readable medium of claim 15, wherein the internal authorization request further causes the client device to perform operation comprising:
capturing an image of a user using the client device;
comparing the image of the user using the client device to a verified image of the user associated with the user account, the verified image stored in the secure hardware of the client device and having been captured by the client device during an enrollment process with the authorization system; and
determining, based on comparing the image of the user using the client device to the verified image of the user associated with the user account, that the user using the client device is the user associated with the user account.

17. The non-transitory computer-readable medium of claim 15, the operations further comprising:
receiving, from the client device, an image of a user using the client device;
comparing the image of the user using the client device to a verified image of the user associated with the user account, the verified image having been received. from the client device during an enrollment process with the authorization system; and
determining, based on comparing the image of the user using the client device to the verified image of the user associated with the user account, that the user using the client device is the user associated with the user account.

18. The non-transitory computer-readable medium of claim 15, wherein the internal authorization request further causes the client device to perform operation comprising:
presenting a prompt to enter a passcode and a biometric data item;
receiving the passcode and biometric data item from a user using the client device; and
verifying the user using the client device based on the passcode and biometric data item.

19. The non-transitory computer-readable medium of claim 15, the operations further comprising:
accessing the public key associated with the user account from a distributed database.

20. The non-transitory computer-readable medium of claim 15, wherein the requested action is transmitting personal information associated with the user account to a recipient, the operations further comprising:
transmitting, to the client device, a public key associated with a user account of the recipient;
receiving, from the client device, encrypted personal information, the personal information having been encrypted by the client device using the public key associated with the user account of the recipient; and
transmitting the encrypted personal information to a second client device associated with the user account of the recipient, the second client device maintaining a private key to decrypt the encrypted personal information.
